(19) United States
(12) Patent Application Publication
(10) Pub. No.: US 2026/0084533 A1
(43) Pub. Date: Mar. 26, 2026

(54) DISPLAY CONTROL DEVICE AND DISPLAY CONTROL METHOD

(71) Applicant: Panasonic Automotive Systems Co., Ltd., Kanagawa (JP)

(72) Inventors: Takanori SAKATA, Kanagawa (JP); Tadashi YOSHIDA, Osaka (JP)

(73) Assignee: Panasonic Automotive Systems Co., Ltd., Kanagawa (JP)

(21) Appl. No.: 19/408,757

(22) Filed: Dec. 4, 2025

Related U.S. Application Data
(63) Continuation of application No. PCT/JP2024/028517, filed on Aug. 8, 2024.

(30) Foreign Application Priority Data
Sep. 28, 2023 (JP) 2023-167767

(51) Int. Cl. B60K 35/81; B60K 35/22; G06F 3/04817; G06F 3/04842; G06F 3/0488; G06F 3/14

(52) U.S. Cl. CPC B60K 35/81; B60K 35/22; G06F 3/04817; G06F 3/04842; G06F 3/0488; G06F 3/1423

(57) ABSTRACT

A display control device includes: a first-operation assist that assists a first operation of selecting a second display device from among display devices, each configured to display an image, the second display device being selected to receive an output of and display a target image that is the image displayed on a first display device among the display devices, the second display device being different from the first display device; and a second display controller that outputs the target image to the second display device selected by the first operation to cause the second display device to display the target image.

### CROSS REFERENCE TO RELATED APPLICATIONS

This is a continuation application of PCT International Patent Application No. PCT/JP2024/028517 filed on Aug. 8, 2024, designating the United States of America, which is based on and claims priority of Japanese Patent Application No. 2023-167767 filed on Sepmtember 28, 2023.

### FIELD

The present disclosure relates to, for example, a display control device.

### BACKGROUND

For example, a device that controls displaying of an image on a display located in a vehicle is conventionally disclosed. For instance, Patent Literature (PTL) 1 discloses an in-vehicle display system that, when a display operation to output at least a part of first content to a second display is performed with the first content being output by a first display, selects either the first display or the second display to be associated with a permission to operate the output of at least one of the first display or the second display.

### CITATION LIST

### Patent Literature

PTL 1: International Publication WO 2017/068759

### SUMMARY

However, the display control disclosed in PTL 1 can be improved upon.

In view of this, the present disclosure provides a display control device and so forth capable of improving upon the above related art.

A display control device according to one aspect of the present disclosure includes: a first-operation assist that assists a first operation of selecting a second display device from among a plurality of display devices, each configured to display an image, the second display device being selected to receive an output of and display a target image that is the image displayed on a first display device among the plurality of display devices, the second display device being different from the first display device; and a controller that outputs the target image to the second display device selected by the first operation to cause the second display device to display the target image.

Moreover, a display control method according to another aspect of the present disclosure includes: assisting a first operation of selecting a second display device from among a plurality of display devices, each configured to display an image, the second display device being selected to receive an output of and display a target image that is the image displayed on a first display device among the plurality of display devices, the second display device being different from the first display device; and outputting the target image to the second display device selected by the first operation to cause the second display device to display the target image.

Moreover, a program according to another aspect of the present disclosure is a program for causing a computer to execute the above display control method.

It should be noted that these general or specific aspects may be achieved as a system, a method, an integrated circuit, a computer program, or a computer-readable recording medium such as a CD-ROM or may be achieved as any combination of the system, method, integrated circuit, computer program, and recording medium. Moreover, the recording medium may be a non-transitory recording medium.

A display control device and so forth in the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic configuration of a vehicle including a display control device according to an embodiment.

FIG. 2 is a block diagram illustrating a functional configuration of the display control device illustrated in FIG. 1.

FIG. 3 is a schematic diagram illustrating an example of pieces of control equipment that control a plurality of display devices.

FIG. 4 is a schematic diagram illustrating an example of another control equipment that controls the plurality of display devices.

FIG. 5 is a flowchart illustrating an example of a display control method performed by the display control device illustrated in FIG. 1.

FIG. 6 is a figure for explaining a first operation example of the display control device illustrated in FIG. 1.

FIG. 7 is a figure for explaining a second operation example of the display control device illustrated in FIG. 1.

FIG. 8 is a figure for explaining a third operation example of the display control device illustrated in FIG. 1.

FIG. 9 is a figure for explaining a fourth operation example of the display control device illustrated in FIG. 1.

FIG. 10 is a schematic diagram illustrating another example of assistance of a first operation in the first to fourth operation examples.

FIG. 11 is a figure for explaining a fifth operation example of the display control device illustrated in FIG. 1.

FIG. 12 is a figure for explaining a sixth operation example of the display control device illustrated in FIG. 1.

FIG. 13 is a figure for explaining a seventh operation example of the display control device illustrated in FIG. 1.

FIG. 14 is a figure for explaining an eighth operation example of the display control device illustrated in FIG. 1.

FIG. 15 is a figure for explaining a ninth operation example of the display control device illustrated in FIG. 1.

FIG. 16 is a figure for explaining a tenth operation example of the display control device illustrated in FIG. 1.

FIG. 17 is a figure for explaining an eleventh operation example of the display control device illustrated in FIG. 1.

FIG. 18 is a figure for explaining a twelfth operation example of the display control device illustrated in FIG. 1.

FIG. 19 is a schematic diagram illustrating another example of assistance of the first operation in the eleventh and twelfth operation examples.

FIG. 20 is a figure for explaining a thirteenth operation example of the display control device illustrated in FIG. 1.

FIG. 21 is a block diagram illustrating a functional configuration of a display control device according to another embodiment.

### DESCRIPTION OF EMBODIMENT

Incidentally, when an image displayed on a first display device among display devices is output to and displayed on a second display device different from the first display device, an operation of selecting the second display device from among the display devices is performed. However, when a display device different from the second display device is selected incorrectly, the image will be displayed incorrectly on the display device different from the second display device. Thus, it is desirable to be able to more reliably select the second display device and more reliably output and display the image on the second display device. In view of this, the present disclosure provides a display control device and so forth that make it possible to more reliably select a second display device and more reliably output and display an image displayed on a first display device on the second display device.

A display control device according to one aspect of the present disclosure includes: a first-operation assist that assists a first operation of selecting a second display device from among a plurality of display devices, each configured to display an image, the second display device being selected to receive an output of and display a target image that is the image displayed on a first display device among the plurality of display devices, the second display device being different from the first display device; and a controller that outputs the target image to the second display device selected by the first operation to cause the second display device to display the target image.

In this way, it is possible to assist the first operation of selecting the second display device from among the plurality of display devices. Thus, it is possible to more reliably select the second display device and more reliably output and display the image displayed on the first display device on the second display device.

Moreover, in the display control device according to the aspect of the present disclosure, the first-operation assist may assist the first operation by causing the first display device to display (i) an object representing the first display device, (ii) one or more objects representing one or more display devices other than the first display device among the plurality of display devices, and (iii) one or more guide lines extending from the object representing the first display device toward the one or more objects, and the first operation may be an operation of selecting the second display device by swiping along a guide line, among the one or more guide lines, that extends from the object representing the first display device toward an object representing the second display device among the one or more objects.

In this way, it is possible to easily determine which direction to swipe from the object representing the first display device to select the second display device. Thus, it is possible to more reliably select the second display device and more reliably output and display the image displayed on the first display device on the second display device.

Moreover, in the display control device according to the aspect of the present disclosure, target images each of which is the target image may be displayed on the first display device, the display control device may further include: a second-operation acceptor that accepts a second operation of selecting, from the target images, one or more target images to be output to and displayed on the second display device, and the second operation may be an operation of selecting the one or more target images by tapping or swiping the one or more target images.

In this way, it is possible to easily select, from the target images displayed on the first display device, the one or more target images to be output to and displayed on the second display device.

Moreover, in the display control device according to the aspect of the present disclosure, the first-operation assist may assist the first operation by causing the first display device to display an interface including (i) a central area and (ii) one or more areas that are located in a surrounding area of the central area and in each of which a corresponding one of one or more objects representing one or more display devices other than the first display device among the plurality of display devices is located, and the first operation may be an operation of selecting the second display device by flicking from the central area toward an area, among the one or more areas, where an object representing the second display device among the one or more objects is located.

In this way, it is possible to easily determine which direction to flick from the central area to select the second display device. Thus, it is possible to more reliably select the second display device and more reliably output and display the image displayed on the first display device on the second display device.

Moreover, in the display control device according to the aspect of the present disclosure, target images each of which may be the target image are displayed on the first display device, the display control device may further include: a second-operation acceptor that accepts a second operation of selecting, from the target images, one or more target images to be output to and displayed on the second display device, and the second operation may be an operation of selecting the one or more target images by tapping or swiping the one or more target images.

In this way, it is possible to easily select, from the target images displayed on the first display device, the one or more target images to be output to and displayed on the second display device.

Moreover, in the display control device according to the aspect of the present disclosure, the first-operation assist may assist the first operation by causing the first display device to display (i) one or more objects representing one or more display devices other than the first display device among the plurality of display devices and (ii) an object representing the target image, and the first operation may be an operation of selecting the second display device by dragging and dropping the object representing the target image onto an object representing the second display device among the one or more objects.

In this way, by dragging and dropping the object representing the target image onto the object representing the second display device, it is possible to more reliably select the second display device and more reliably output and display the image displayed on the first display device on the second display device.

Moreover, in the display control device according to the aspect of the present disclosure, target images each of which may be the target image may be displayed on the first display device, the display control device may further include: a second-operation acceptor that accepts a second operation of selecting, from the target images, one or more target images to be output to and displayed on the second display device, and the second operation may be an operation of selecting the one or more target images by dragging the object representing the target image onto the one or more target images.

In this way, it is possible to easily select, from the target images displayed on the first display device, the one or more target images to be output to and displayed on the second display device.

Moreover, in the display control device according to the aspect of the present disclosure, the first-operation assist may assist the first operation by causing the first display device to display one or more objects representing one or more display devices other than the first display device among the plurality of display devices, and the first operation may be an operation of selecting the second display device by tapping an object representing the second display device out of the one or more objects.

In this way, by tapping the object representing the second display device, it is possible to more reliably select the second display device and more reliably output and display the image displayed on the first display device on the second display device.

Moreover, in the display control device according to the aspect of the present disclosure, the target images each of which is the target image may be displayed on the first display device, the display control device may further include: a second-operation acceptor that accepts a second operation of selecting, from the target images, one or more target images to be output to and displayed on the second display device, and the second operation may be an operation of selecting the one or more target images by tapping or swiping the one or more target images.

In this way, it is possible to easily select, from the target images displayed on the first display device, the one or more target images to be output to and displayed on the second display device.

Moreover, in the display control device according to the aspect of the present disclosure, the first-operation assist may assist the first operation by causing the first display device to display (i) one or more objects representing one or more display devices other than the first display device among the plurality of display devices and (ii) one or more device names that are one or more names of the one or more display devices represented by the one or more objects, and the first operation may be an operation of selecting the second display device by pronouncing a device name of the second display device out of the one or more device names.

In this way, by pronouncing the device name of the second display device, it is possible to more reliably select the second display device and more reliably output and display the image displayed on the first display device on the second display device.

Moreover, in the display control device the aspect of the present disclosure, target images each of which is the target image may be displayed on the first display device, the display control device may further include: a second-operation acceptor that accepts a second operation of selecting, from the target images, one or more target images to be output to and displayed on the second display device, as a result of causing the first display device to display (i) objects representing the target images and (ii) image names that are names of the target images represented by the objects, and the second operation may be an operation of selecting the one or more target images by pronouncing one or more image names of the one or more target images out of the image names.

In this way, it is possible to easily select, from the target images displayed on the first display device, the one or more target images to be output to and displayed on the second display device.

Moreover, the display control device according to the aspect of the present disclosure may further include: a notifier that notifies a method of the first operation.

In this way, it is possible to more reliably perform the first operation. Thus, it is possible to more reliably select the second display device and more reliably output and display the image displayed on the first display device on the second display device.

Moreover, the display control device according to the aspect of the present disclosure may further include: a third-operation detector that detects a third operation that triggers start of acceptance of the first operation.

In this way, it is possible to recognize that the acceptance of the first operation is to be accepted. Since it is possible to more reliably assist the first operation, it is possible to more reliably select the second display device and more reliably output and display the image displayed on the first display device on the second display device.

Moreover, in the display control device according to the aspect of the present disclosure, each of the plurality of display devices may be located in a vehicle or carried by one or more persons in the vehicle, and the display control device may further include: a decision maker that determines a method of the first operation according to a driving status of the vehicle.

In this way, it is possible to appropriately determine the method of the first operation according to the driving status of the vehicle. Thus, it is possible to more reliably select the second display device and more reliably output and display the image displayed on the first display device on the second display device.

Moreover, in the display control device according to the aspect of the present disclosure, each of the plurality of display devices may be located in a vehicle or carried by one or more persons in the vehicle, and the display control device may further include: a setting acceptor that accepts a setting to prohibit the first operation using at least one of the plurality of display devices.

In this way, it is possible to suppress the first operation from becoming a disturbance to the driving of the vehicle.

Moreover, a display control method according to another aspect of the present disclosure includes: assisting a first operation of selecting a second display device from among a plurality of display devices, each configured to display an image, the second display device being selected to receive an output of and display a target image that is the image displayed on a first display device among the plurality of display devices, the second display device being different from the first display device; and outputting the target image to the second display device selected by the first operation to cause the second display device to display the target image.

The display control method has an advantage similar to that of the above display control device.

Moreover, a program according to another aspect of the present disclosure is a program for causing a computer to execute the above display control method.

The program has an advantage similar to that of the above display control device.

Embodiments are described below in detail with reference to the drawings.

It should be noted that the embodiments described below each indicate a comprehensive or specific example. The numerical values, shapes, materials, constituent elements, arrangement and connection of the constituent elements, steps, order of steps, and other details indicated in the embodiments described below are merely examples, and do not intend to limit the present disclosure. Moreover, among the constituent elements included in the embodiments below, those not recited in any of the independent claims are described as optional constituent elements. Furthermore, the figures are schematic illustrations and are not necessarily precise depictions. In addition, identical constituent elements are assigned the same reference sign in the figures.

### Embodiment

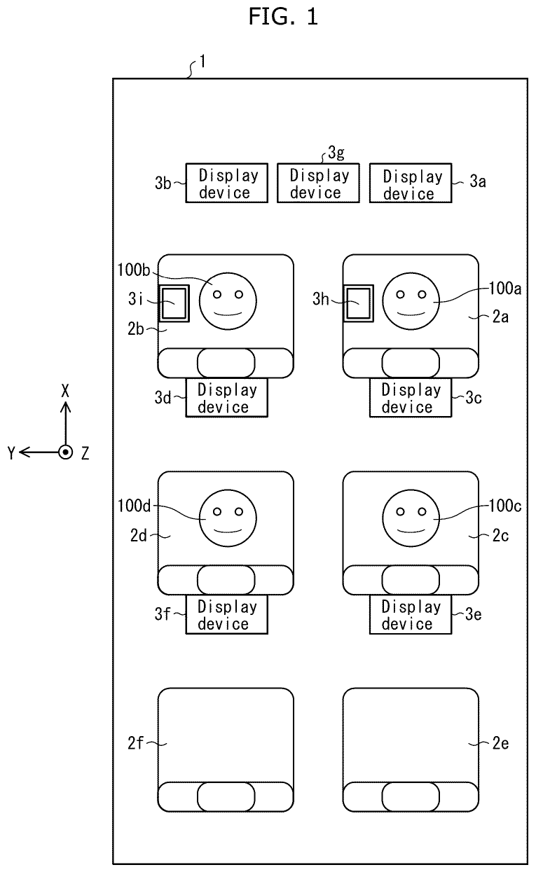

FIG. 1 is a schematic diagram illustrating vehicle 1 including display control device 10 (described later) according to an embodiment. First, vehicle 1 is described with reference to FIG. 1.

In FIG. 1, an X-axis direction indicates a front-rear direction of vehicle 1, the positive side of the X-axis direction indicates the front side, and the negative side of the X-axis direction indicates the rear side. Moreover, a Y-axis direction indicates a lateral direction of vehicle 1, the positive side of the Y-axis direction indicates the left side, and the negative side of the Y-axis direction indicates the right side. Moreover, a Z-axis direction indicates a vertical direction of vehicle 1, the positive side of the Z-axis direction indicates the upper side, and the negative side of the Z-axis direction indicates the lower side.

As illustrated in FIG. 1, vehicle 1 includes seats 2a to 2f and display devices 3a to 3i. For instance, vehicle 1 is an automobile.

Seat 2a is a driver's seat. Seat 2b is a front seat next to the driver's seat. Seat 2c is a second seat on the right side. Seat 2d is a second seat on the left side. Seat 2e is a third seat on the right side. Seat 2f is a third seat on the left side. Here, person 100a is seated in seat 2a, person 100b is seated in seat 2b, person 100c is seated in seat 2c, and person 100d is seated in seat 2d.

Each of display devices 3a to 3i is capable of displaying an image. For instance, the image is an application image. Each of display devices 3a to 3i is located in vehicle 1 or carried by one or more persons in vehicle 1. Specifically, display devices 3a to 3g are located in vehicle 1. Moreover, display device 3h is carried by person 100a in vehicle 1, and display device 3i is carried by person 100b in vehicle 1.

Display devices 3a to 3i include display devices that have a one-to-one correspondence with seats 2a to 2f and are each configured to display an image viewable by a person seated in a corresponding one of the seats. Specifically, display device 3a corresponds to seat 2a, and is capable of displaying an image viewable by person 100a seated in seat 2a. Display device 3b corresponds to seat 2b, and is capable of displaying an image viewable by person 100b seated in seat 2b. Display device 3c corresponds to seat 2c, and is capable of displaying an image viewable by person 100c seated in seat 2c. Display device 3d corresponds to seat 2d, and is capable of displaying an image viewable by person 100d seated in seat 2d. Display device 3e corresponds to seat 2e, and is capable of displaying an image viewable by a person seated in seat 2e. Display device 3f corresponds to seat 2f, and is capable of displaying an image viewable by a person seated in seat 2f. Display device 3g is located between display device 3a and display device 3b, and is capable of displaying an image viewable by person 100a seated in seat 2a and person 100b seated in seat 2b. For instance, display devices 3a, 3b, and 3g are located on the dashboard of vehicle 1. Display device 3c is located on the headrest of seat 2a or the ceiling of vehicle 1. Display device 3d is located on the headrest of seat 2b or the ceiling of vehicle 1. Display device 3e is located on the headrest of seat 2c or the ceiling of vehicle 1. Display device 3f is located on the headrest of seat 2d or the ceiling of vehicle 1. Each of display devices 3a to 3g includes, for example, a touch panel display.

Display devices 3h and 3i are display devices of portable terminals. Here, display device 3h is a display device of a portable terminal of person 100a seated in seat 2a, and display device 3i is a display device of a portable terminal of person 100b seated in seat 2b. The portable terminals are, for example, smartphones or tablet terminals.

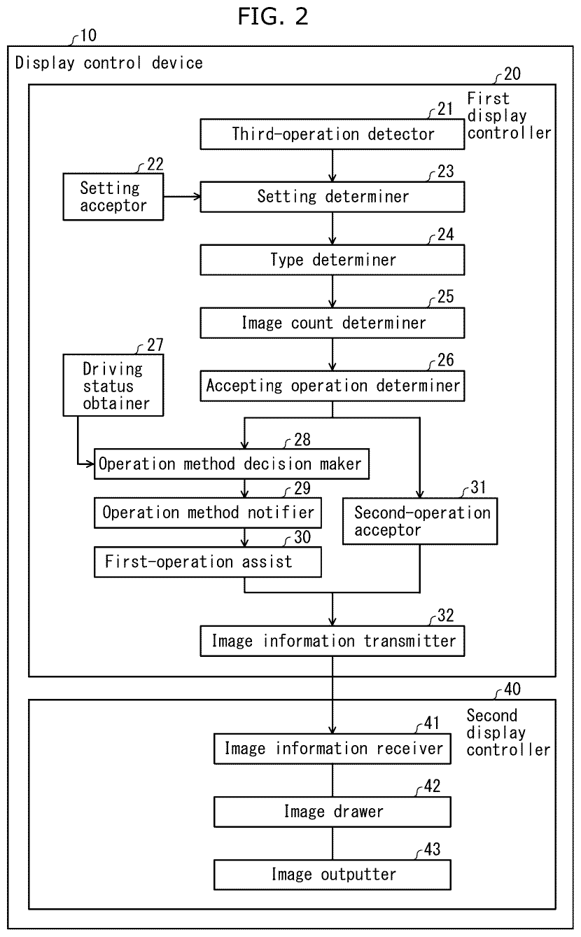

FIG. 2 is a block diagram illustrating a functional configuration of display control device 10 in FIG. 1. Next, a functional configuration of display control device 10 is described with reference to FIG. 2.

As illustrated in FIG. 2, display control device 10 includes first display controller 20 and second display controller 40. For instance, display control device 10 is achieved using a central processing unit (CPU), memory, storage, a communication interface, and a system on chip (SoC). Display control device 10 is capable of communicating with display devices 3h and 3i via the communication interface. Moreover, display control device 10 is capable of controlling display devices 3a to 3g using the SoC.

First display controller 20 incudes third-operation detector 21, setting acceptor 22, setting determiner 23, type determiner 24, image count determiner 25, accepting operation determiner 26, driving status obtainer 27, operation method decision maker 28, operation method notifier 29, first-operation assist 30, second-operation acceptor 31, and image information transmitter 32.

Third-operation detector 21 detects a third operation. The third operation is an operation that triggers the start of acceptance of a first operation. That is, when the third operation is performed, the acceptance of the first operation starts. The first operation is an operation of selecting, from among display devices 3a to 3i, a second display device different from a first display device in order to output and display, on the second display device, a target image that is an image displayed on the first display device among display devices 3a to 3i. For instance, when the third operation is performed, information indicating that the third operation has been performed is transmitted to third-operation detector 21. Third-operation detector 21 detects the third operation by obtaining the information.

The third operation can be performed using each of display devices 3a to 3i. When the third operation is performed using the display device, the display device transmits, to third-operation detector 21, the information indicating that the third operation has been performed. The third operation is performed by, for example, persons 100a to 100d. In the embodiment, among display devices 3a to 3i, a display device on which the third operation has been performed serves as the first display device. The acceptance of the first operation is started using the first display device.

For instance, the third operation is an operation of long-pressing or tapping a display surface with a finger or fingers. Moreover, the third operation is an operation of tapping the display surface any number of times in a relatively short period. Moreover, the third operation is an operation of long-pressing or tapping a predetermined region of a displayed image. Moreover, the third operation is an operation, which is performed after long-pressing the display surface, of moving a finger as if drawing a shape, such as a circle or triangle, on the display surface. It should be noted that a method of the third operation may be set to be anything, or may be preset. Moreover, whether to copy, move, or mirror the target image to the second display device may be determined according to, for example, the number of fingers that perform the third operation.

Setting acceptor 22 accepts a setting to prohibit the first operation using at least one of display devices 3a to 3i. For instance, a button or the like for setting the setting to prohibit the first operation using display device 3b corresponding to seat 2b is located in vehicle 1. Setting acceptor 22 accepts, via the button, the setting to prohibit the first operation using display device 3b. Setting acceptor 22 sets the setting to prohibit the first operation using display device 3b in the period during which the button is pressed. When the button is not pressed, setting acceptor 22 disables the setting. It should be noted that setting acceptor 22 may set the setting to prohibit the first operation using display device 3b when the button is pressed, and setting acceptor 22 may disable the setting when the button is pressed again. Moreover, setting acceptor 22 may be capable of displaying, on each of display devices 3a to 3i, a setting screen on which to accept the setting to prohibit the first operation using the display device, and setting acceptor 22 may accept the setting as a result of causing the display device to display the setting screen.

Setting determiner 23 determines whether the setting to prohibit the first operation using the first display device is set.

Type determiner 24 determines which type among moving, copying, and mirroring is used to output the target image to the second display device selected by the first operation. For instance, on the basis of the third operation, type determiner 24 determines which type is used to output the target image. Specifically, type determiner 24 determines which type is used to output the target image, according to the details of the third operation (for example, the number of fingers that perform the third operation). It should be noted that which type is used to output the target image may be predetermined, or may be selected by an operation different from the third operation. When the target image is moved to the second display device, the target image that has been displayed on the first display device is displayed on the second display device. At the same time, the target image will no longer be displayed on the first display device. When the target image is copied to the second display device, the target image displayed on the first display device is also displayed on the second display device. The first display device and the second display device can be, for example, operated independently of each other using the target image. When the target image is mirrored to the second display device, the target image displayed on the first display device is also displayed on the second display device. When an operation or the like using the target image is performed on the first display device, the operation or the like using the target image is performed on the second display device in the same way.

Image count determiner 25 determines the number of target images that are images displayed on the first display device. As described above, for instance, the images are application images.

On the basis of the number of target images, accepting operation determiner 26 determines whether to accept both the first operation and the second operation or only the first operation. Specifically, when target images are displayed on the first display device, accepting operation determiner 26 determines that both the first operation and the second operation are to be accepted. When a single target image is displayed instead of target images, accepting operation determiner 26 determines that only the first operation out of the first operation and the second operation is to be accepted.

Driving status obtainer 27 obtains a driving status of vehicle 1. For instance, the driving status is obtained from, for example, a sensor cluster attached to vehicle 1, an occupant monitoring system provided in vehicle 1, and a navigation system provided in vehicle 1. The sensor cluster includes, for example, a vibration sensor and an acceleration sensor.

Operation method decision maker 28 is an example of a decision maker that determines a method of the first operation on the basis of the driving status of vehicle 1. Specifically, on the basis of the driving status of vehicle 1, operation method decision maker 28 determines whether the first operation involves a swipe, flick, drag, tap, or voice. For instance, when the vibration of vehicle 1 has a magnitude greater than or equal to a predetermined magnitude, operation method decision maker 28 determines the method of the first operation of selecting the second display device to be a tap. Moreover, when vehicle 1 is stationary, operation method decision maker 28 determines the method of the first operation of selecting the second display device to be a preset method. Moreover, when a state where a steering wheel is turned to left by a predetermined angle or greater alternates with a state where the steering wheel is turned to right by a predetermined angle or larger, operation method decision maker 28 determines the method of the first operation of selecting the second display device to be a tap. Moreover, when a state where the acceleration in the left direction of the lateral direction of vehicle 1 is greater than or equal to predetermined acceleration alternates with a state where the acceleration in the right direction of the lateral direction of vehicle 1 is greater than or equal to predetermined acceleration, operation method decision maker 28 determines the method of the first operation of selecting the second display device to be a tap. Moreover, when person 100a (a driver) seated in seat 2a is looking to the side, operation method decision maker 28 determines the method of the first operation of selecting the second display device to be a voice. Moreover, in a predetermined area including a left-turn location on a traveling route of vehicle 1 and a predetermined area including a right-turn location, operation method decision maker 28 determines the method of the first operation of selecting the second display device to be a voice. It should be noted that the method of the first operation may be predetermined or may be determined by the details of the third operation.

Operation method notifier 29 notifies the method of the first operation determined by operation method decision maker 28. For instance, operation method notifier 29 notifies the method of the first operation by causing the first display device to display the method of the first operation. It should be noted that operation method notifier 29 may notify the method of the first operation by pronouncing the method of the first operation.

First-operation assist 30 assists the first operation of selecting the second display device from among display devices 3a to 3i, each configured to display an image, the second display device being selected to receive an output of and display the target image that is the image displayed on the first display device among display devices 3a to 3i, the second display device being different from the first display device.

When there are target images, second-operation acceptor 31 accepts a second operation of selecting, from the target images, one or more target images to be output to and displayed on the second display device.

When each of display devices 3a to 3i is the first display device, the first operation and the second operation can be performed using the display device. The first operation and the second operation are performed by, for example, persons 100a to 100d.

For instance, first-operation assist 30 assists the first operation by causing the first display device to display (i) an object representing the first display device, (ii) one or more objects representing one or more display devices other than the first display device among display devices 3a to 3i, and (iii) one or more guide lines extending from the object representing the first display device toward the one or more objects representing the one or more display devices. In this case, the first operation is an operation of selecting the second display device by swiping along a guide line extending from the object representing the first display device toward an object representing the second display device among the one or more objects representing the one or more display devices.

In this case, second-operation acceptor 31 accepts the second operation of selecting, from the target images, one or more target images to be output to and displayed on the second display device, as a result of causing the first display device to display the target images together with (i) the object representing the first display device, (ii) the one or more objects representing the one or more display devices, and (iii) the one or more guide lines extending from the object representing the first display device toward the one or more objects. Moreover, as a result of causing the first display device to display the target images before the object representing the first display device and so forth are displayed, second-operation acceptor 31 accepts the second operation of selecting, from the target images, one or more target images to be output to and displayed on the second display device. In this case, the second operation is an operation of selecting the one or more target images by tapping or swiping the one or more target images.

It should be noted that hereinafter, one or more objects representing one or more display devices other than the first display device among display devices 3a to 3i may be simply referred to as one or more objects.

For instance, first-operation assist 30 assists the first operation by causing the first display device to display an interface including (i) a central area and (ii) one or more areas that are located in a surrounding area of the central area and in each of which a corresponding one of the one or more objects is located. In this case, the first operation is an operation of selecting the second display device by flicking from the central area toward an area where an object representing the second display device among the one or more objects is located.

In this case, second-operation acceptor 31 accepts the second operation of selecting, from the target images, one or more target images to be output to and displayed on the second display device, as a result of causing the first display device to display the target images together with the interface including the central area and the one or more areas. Moreover, as a result of causing the first display device to display the target images before the interface is displayed, second-operation acceptor 31 accepts the second operation of selecting, from the target images, one or more target images to be output to and displayed on the second display device. In this case, the second operation is an operation of selecting the one or more target images by tapping or swiping the one or more target images.

For instance, first-operation assist 30 assists the first operation by causing the first display device to display (i) one or more objects representing one or more display devices other than the first display device among display devices 3a to 3i and (ii) an object representing a target image. In this case, the first operation is an operation of selecting the second display device by dragging and dropping the object representing the target image onto the object representing the second display device among the one or more objects.

In this case, second-operation acceptor 31 accepts the second operation of selecting, from the target images, one or more target images to be output to and displayed on the second display device, as a result of causing the first display device to display the target images together with the one or more objects representing the one or more display devices other than the first display device and the object representing the target image. In this case, the second operation is an operation of selecting the one or more target images by dragging the object representing the target image onto the one or more target images.

Moreover, as a result of causing first display device to display the target images before the one or more objects representing the one or more display devices other than the first display device and so forth are displayed, second-operation acceptor 31 accepts the second operation of selecting, from the target images, one or more target images to be output to and displayed on the second display device. In this case, the second operation is an operation of selecting the one or more target images by tapping or swiping the one or more target images.

For instance, first-operation assist 30 assists the first operation by causing the first display device to display one or more objects representing one or more display devices other than the first display device among display devices 3a to 3i. In this case, the first operation is an operation of selecting the second display device by tapping the object representing the second display device out of the one or more objects representing the one or more display devices other than the first display device.

In this case, second-operation acceptor 31 accepts the second operation of selecting, from the target images, one or more target images to be output to and displayed on the second display device, as a result of causing the first display device to display the target images together with the one or more objects representing the one or more display devices other than the first display device. Moreover, as a result of causing the first display device to display the target images before the one or more objects representing the one or more display devices other than the first display device are displayed, second-operation acceptor 31 accepts the second operation of selecting, from the target images, one or more target images to be output to and displayed on the second display device. In this case, the second operation is an operation of selecting the one or more target images by tapping or swiping the one or more target images.

For instance, first-operation assist 30 assists the first operation by causing the first display device to display (i) one or more objects representing one or more display devices other than the first display device among display devices 3a to 3i and (ii) one or more device names that are the names of the one or more display devices represented by the one or more objects representing the one or more display devices other than the first display device. In this case, the first operation is an operation of selecting the second display device by pronouncing the device name of the second display device out of the one or more device names.

In this case, second-operation acceptor 31 accepts the second operation of selecting, from the target images, one or more target images to be output to and displayed on the second display device, as a result of causing the first display device to display objects representing the target images and image names that are the names of the target images represented by the target objects, together with the one or more objects representing the one or more display devices other than the first display device and the one or more device names. Moreover, as a result of causing the first display device to display the objects representing the target images and the image names that are the names of the target images represented by the target objects before the one or more objects representing the one or more display devices other than the first display device and so forth are displayed, second-operation acceptor 31 accepts the second operation of selecting, from the target images, one or more target images to be output to and displayed on the second display device. In this case, the second operation is an operation of selecting one or more target images by pronouncing the one or more image names of the one or more target images out of the image names.

Image information transmitter 32 transmits image information regarding the one or more target images to be output to and displayed on the second display device.

Second display controller 40 is an example of a controller that outputs the target image to the second display device selected by the first operation to cause the second display device to display the target image. Second display controller 40 includes image information receiver 41, image drawer 42, and image outputter 43.

Image information receiver 41 receives the image information transmitted by image information transmitter 32.

Image drawer 42 draws one or more target images according to the image information received by image information receiver 41.

Image outputter 43 outputs the one or more target images drawn by image drawer 42 to the second display device to cause the second display device to display the one or more target images.

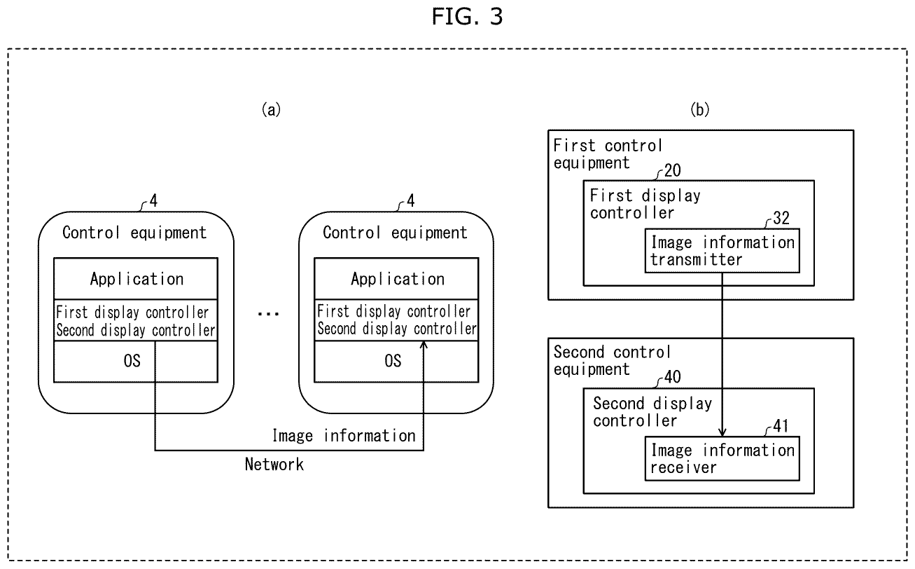

FIG. 3 is a schematic diagram illustrating an example of pieces of control equipment 4 that control display devices 3a to 3i. Next, an example of pieces of control equipment 4 that control display devices 3a to 3i is described with reference to FIG. 3.

As illustrated in (a) in FIG. 3, for each of display devices 3a to 3i, control equipment 4 that controls the display device is provided. For instance, in this case, first display controller 20 and second display controller 40 are provided in each of the pieces of control equipment 4.

As illustrated in (b) in FIG. 3, the image information is transmitted from image information transmitter 32 of first display controller 20 in first control equipment that is control equipment 4 for controlling the first display device, to image information receiver 41 of second display controller 40 in second control equipment that is control equipment 4 for controlling the second display device. In this way, the target image is displayed on the second display device.

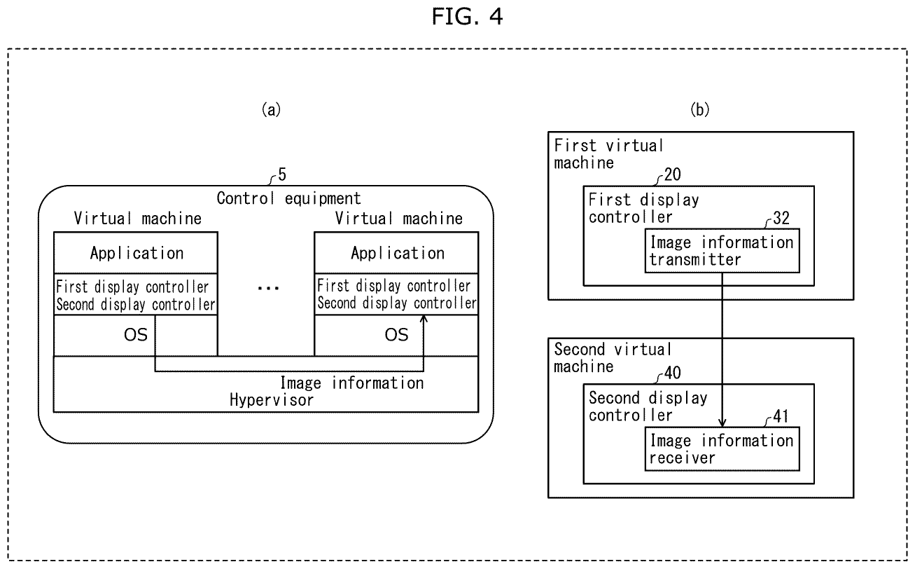

FIG. 4 is a schematic diagram illustrating an example of control equipment 5 that is another control equipment for controlling display devices 3a to 3i. Next, an example of control equipment 5 that is another control equipment for controlling display devices 3a to 3i is described with reference to FIG. 4.

As illustrated in (a) in FIG. 4, control equipment 5 that controls display devices 3a to 3i is provided. For instance, in this case, control equipment 5 is provided with virtual machines each of which controls a corresponding one of display devices 3a to 3i. First display controller 20 and second display controller 40 are provided for each of the virtual machines.

As illustrated in (b) in FIG. 4, the image information is transmitted from image information transmitter 32 of first display controller 20 in a first virtual machine that is a virtual machine for controlling the first display device, to image information receiver 41 of second display controller 40 in a second virtual machine that is a virtual machine for controlling the second display device. In this way, the target image is displayed on the second display device.

As illustrated in FIGS. 3 and 4, display control device 10 may include first display controller 20 and second display controller 40 that correspond to each of display devices 3a to 3i.

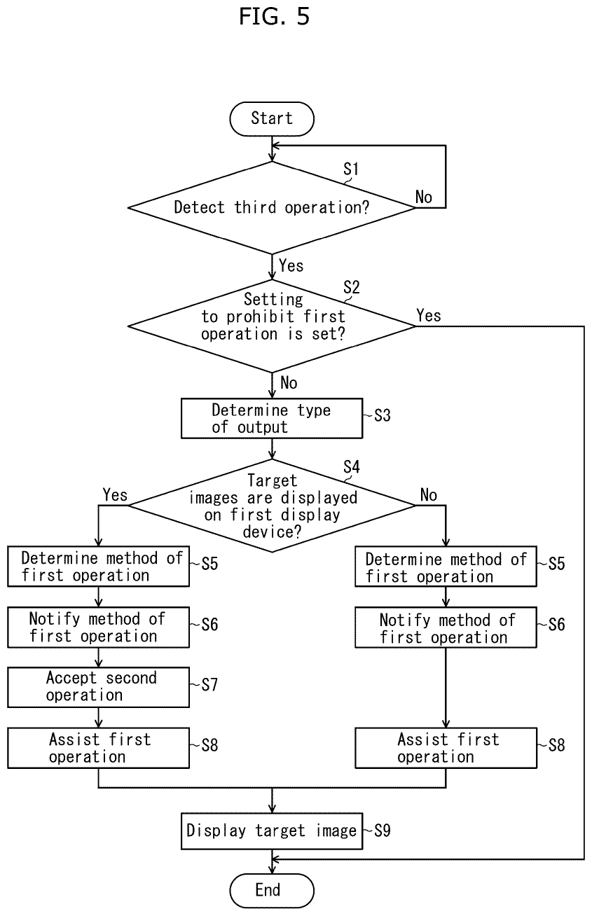

FIG. 5 is a flowchart illustrating an example of a display control method performed by display control device 10 in FIG. 1. Next, an example of a display control method performed by display control device 10 is described with reference to FIG. 5.

As illustrated in FIG. 5, third-operation detector 21 determines whether the third operation has been detected (step S1).

When the third operation is not detected (No in step S1), third-operation detector 21 redetermines whether the third operation has been detected (step S1).

When the third operation is detected (Yes in step S1), setting determiner 23 determines whether a setting to prohibit the first operation is set (step S2). Here, among display devices 3a to 3i, a display device on which the third operation has been performed serves as the first display device. Setting determiner 23 determines whether the setting to prohibit the first operation is set for the display device, among display devices 3a to 3i, on which the third operation has been performed.

When the setting to prohibit the first operation is set (Yes in step S2), display control device 10 ends processing.

When the setting to prohibit the first operation is not set (No in step S2), type determiner 24 determines the type of output (step S3). For instance, according to the details of the third operation, type determiner 24 determines which type among moving, copying, and mirroring is used to output a target image.

Image count determiner 25 determines whether target images are displayed on the first display device (step S4). Here, among display devices 3a to 3i, a display device on which the third operation has been performed serves as the first display device. Thus, setting determiner 23 determines whether target images are displayed on the display device, among display devices 3a to 3i, on which the third operation has been performed.

When target images are displayed on the first display device (Yes in step S4), operation method decision maker 28 determines the method of the first operation (step S5), operation method notifier 29 notifies the method of the first operation (step S6), second-operation acceptor 31 accepts the second operation (step S7), and first-operation assist 30 assists the first operation (first-operation assisting step) (step S8).

Meanwhile, when target images are not displayed on the first display device (No in step S4), operation method decision maker 28 determines the method of the first operation (step S5), operation method notifier 29 notifies the method of the first operation (step S6), and first-operation assist 30 assists the first operation (first-operation assisting step) (step S8).

Second display controller 40 outputs one or more target images to the second display device determined by the first operation to cause the second display device to display the one or more target images (control step) (step S9).

It should be noted that after the third operation is detected (after step S1), when an operation of stopping outputting and displaying a target image on the second display device is performed, the subsequent processing of step S2 is cancelled.

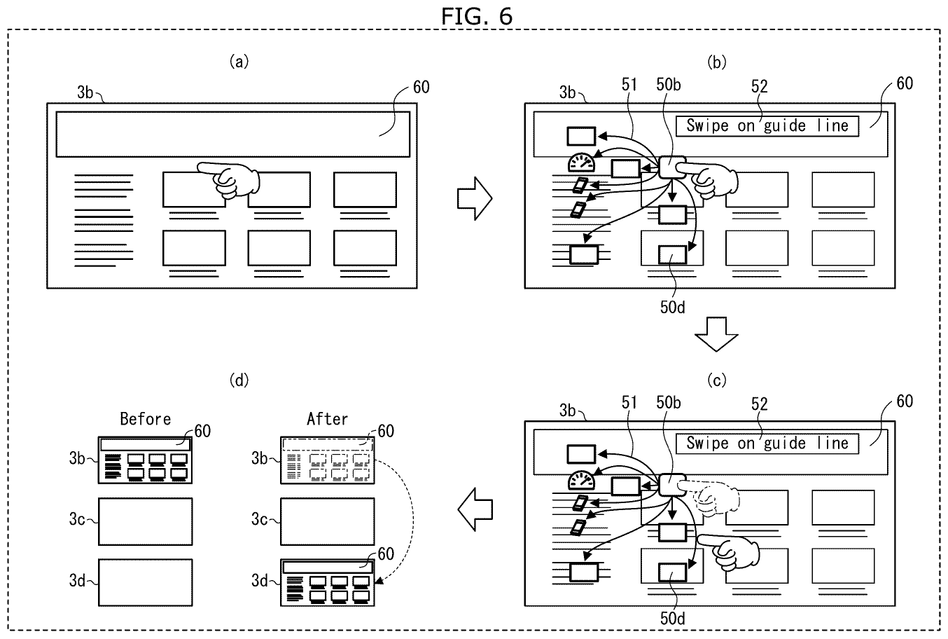

FIGS. 6 to 9 are figures for explaining first to fourth operation examples of display control device 10 in FIG. 1. Next, the first to fourth operation examples of display control device 10 are described with reference to FIGS. 6 to 9.

First, the first operation example is described with reference to FIG. 6. (a) to (c) in FIG. 6 illustrate the first display device, and (d) in FIG. 6 illustrates the first display device, the second display device, and so forth.

As illustrated in (a) in FIG. 6, image 60 is displayed on display device 3b. When the third operation is performed on display device 3b, as illustrated in (b) in FIG. 6, first-operation assist 30 assists the first operation by causing display device 3b to display (i) object 50b representing display device 3b among display devices 3a to 3i, (ii) one or more objects representing one or more display devices other than display device 3b, and one or more guide lines 51 extending from object 50b toward the one or more objects.

For instance, first-operation assist 30 may cause display device 3b to display object 50b at a given location or a location touched by a finger that performed the third operation. Moreover, first-operation assist 30 may locate object 50b representing display device 3b and the one or more objects representing the one or more display devices other than display device 3b, to match the actual positional relationship between display device 3b and the one or more display devices other than display device 3b. It should be noted that when the objects overlap each other, objects are shifted so as not to overlap each other when displayed. Moreover, when the one or more objects representing the one or more display devices other than display device 3b are a plurality of objects, first-operation assist 30 may radially arrange the one or more objects around object 50b representing display device 3b. Moreover, first-operation assist 30 may arrange, in a line or in multiple lines, object 50b representing display device 3b and the one or more objects representing the one or more display devices other than display device 3b. Moreover, for example, the name, identification code, and/or position of a display device may be listed alongside each of object 50b representing display device 3b and the one or more objects representing the one or more display devices other than display device 3b, for identification of a display device represented by the object.

Among object 50b representing display device 3b and the one or more objects representing the one or more display devices other than display device 3b, objects representing the same type of display devices have the same shape, and objects representing different types of display devices have different shapes. Specifically, among object 50b representing display device 3b and the one or more objects representing the one or more display devices other than display device 3b, objects representing display devices 3a to 3g located in vehicle 1 are rectangular display icons and have the same shape. Moreover, among object 50b representing display device 3b and the one or more objects representing the one or more display devices other than display device 3b, objects representing display device 3h and display device 3i carried by person 100a and person 100b in vehicle 1 are smartphone icons and have the same shape. The shape of the objects representing display devices 3a to 3g differs from that of the objects representing display devices 3h and 3i.

Operation method notifier 29 notifies the method of the first operation by causing display device 3b to display message 52 indicating the method of the first operation.

It should be noted that by showing the periphery of image 60 in bold, for example, it may be shown that image 60 is an image to be output to the second display device.

As illustrated in (c) in FIG. 6, display device 3d is selected as the second display device by swiping along guide line 51 extending from object 50b representing display device 3b toward object 50d representing display device 3d. In this way, as illustrated in (d) in FIG. 6, image 60 displayed on display device 3b is output to and displayed on display device 3d.

It should be noted that a finger swiping along guide line 51 may leave guide line 51 midway. Moreover, when the finger swipes along guide line 51, then moves back to object 50b from midway, and leaves object 50b, the processing may be stopped and return to the state illustrated in (a) in FIG. 6.

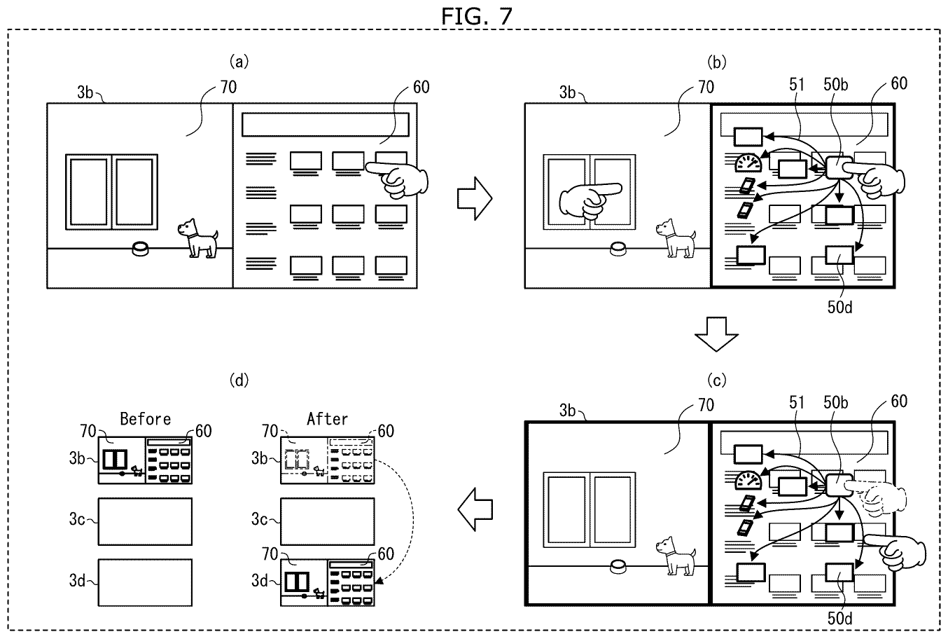

Next, the second operation example is described with reference to FIG. 7. (a) to (c) in FIG. 7 illustrate the first display device, and (d) in FIG. 7 illustrates the first display device, the second display device, and so forth. The second operation example differs from the first operation example mainly in the following points.

As illustrated in (a) in FIG. 7, image 60 and image 70 are displayed on display device 3b. When the third operation is performed on display device 3b, as illustrated in (b) in FIG. 7, first-operation assist 30 assists the first operation by causing display device 3b to display (i) object 50b representing display device 3b among display devices 3a to 3i, (ii) one or more objects representing one or more display devices other than display device 3b, and one or more guide lines 51 extending from object 50b toward the one or more objects.

Moreover, second-operation acceptor 31 accepts the second operation as a result of causing display device 3b to display image 60 and image 70. Here, image 60 and image 70 are displayed lighter than object 50b and so forth. For instance, the second operation is performed with a finger different from a swiping finger. The periphery of the image selected by the second operation is shown in bold, which indicates that the image has been selected as an image to be output to the second display device.

As illustrated in (c) in FIG. 7, after image 60 and image 70 to be output are selected from image 60 and image 70 by swiping or tapping, display device 3d is selected as the second display device by swiping along guide line 51 extending from object 50b representing display device 3b toward object 50d representing display device 3d. In this way, as illustrated in (d) in FIG. 7, image 60 and image 70 displayed on display device 3b are output to and displayed on display device 3d. It should be noted that the selection is cleared by tapping or swiping selected images 60 and 70 again.

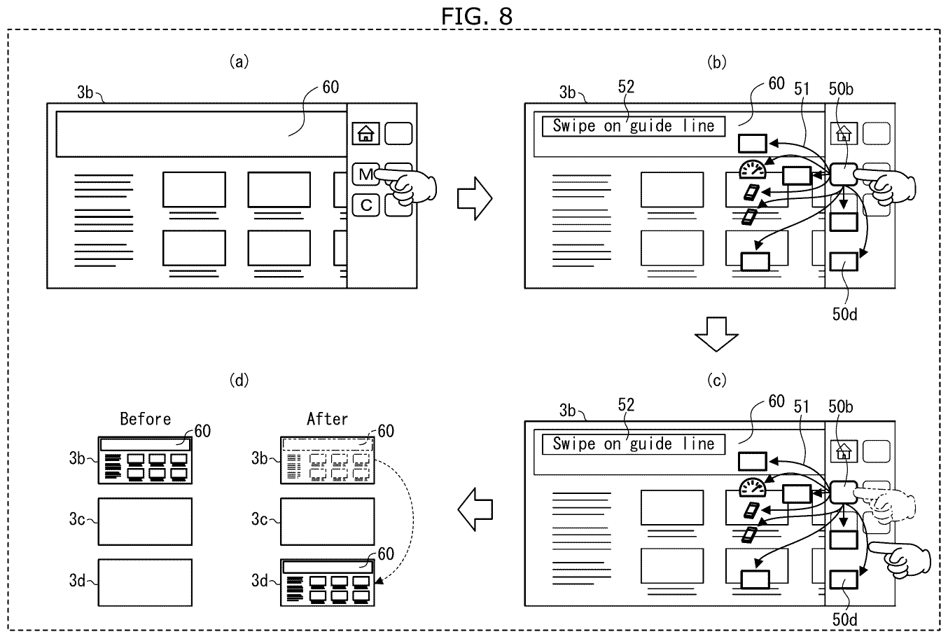

Next, the third operation example is described with reference to FIG. 8. (a) to (c) in FIG. 8 illustrate the first display device, and (d) in FIG. 8 illustrates the first display device, the second display device, and so forth. The third operation example differs from the first operation example mainly in the following points.

As illustrated in (a) in FIG. 8, a button for accepting the third operation is displayed on display device 3b. The third operation is performed by touching or long-pressing the button. It should be noted that a button for accepting the third operation may be provided for each of types, such as moving, copying, and mirroring. Moreover, a position at which to display the button for accepting the third operation may be fixed or vary depending on the position of the first display device. For instance, when a display device located on the right side relative to the center in the lateral direction of vehicle 1 is the first display device, the button may be displayed on the right side relative to the center of the first display device. When a display device located on the left side relative to the center in the lateral direction of vehicle 1 is the first display device, the button may be displayed on the left side relative to the center of the first display device.

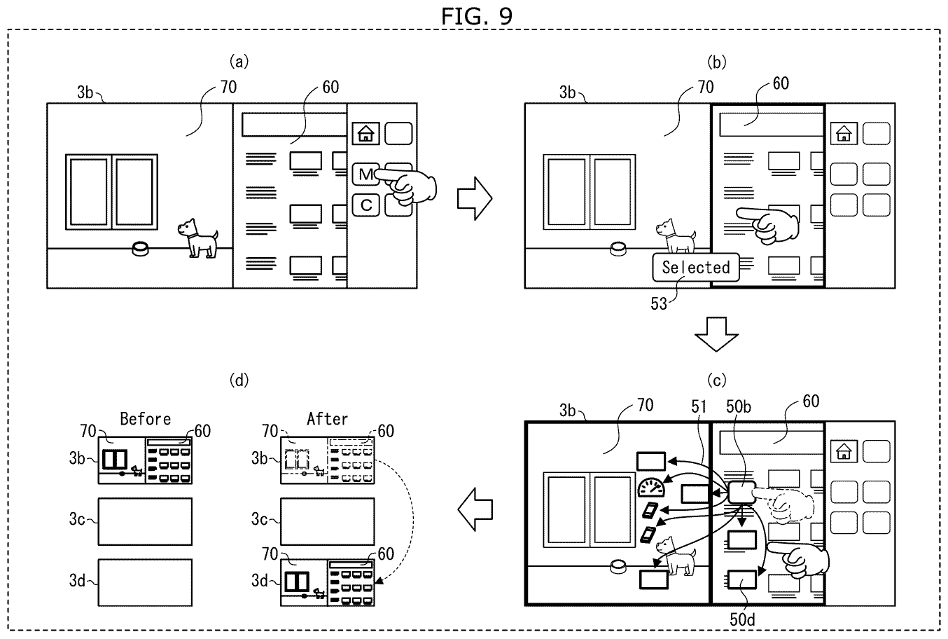

Next, the fourth operation example is described with reference to FIG. 9. (a) to (c) in FIG. 9 illustrate the first display device, and (d) in FIG. 9 illustrates the first display device, the second display device, and so forth. The fourth operation example differs from the second operation example mainly in the following points.

As illustrated in (a) in FIG. 9, a button for accepting the third operation is displayed on display device 3b. The third operation is performed by touching or long-pressing the button.

As illustrated in (b) in FIG. 9, when the third operation is performed, second-operation acceptor 31 accepts the second operation as a result of causing image 60 and image 70 to be displayed. Here, the second operation is accepted before object 50b and so forth are displayed. After one or more images to be output to the second display device are selected from image 60 and image 70 by tapping or swiping, when icon 53 is tapped, the second operation ends.

As illustrated in (c) in FIG. 9, when icon 53 is tapped, first-operation assist 30 assists the first operation by causing object 50b and so forth to be displayed.

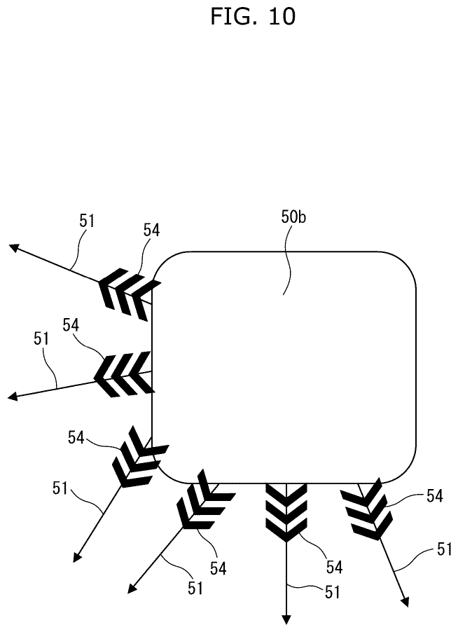

FIG. 10 is a schematic diagram illustrating another example of assistance of the first operation in the first to fourth operation examples. Next, another example of the assistance of the first operation in the first to fourth operation examples is described with reference to FIG. 10.

As illustrated in FIG. 10, for example, icon 54 for prompting a swipe may be displayed in addition to guide line 51.

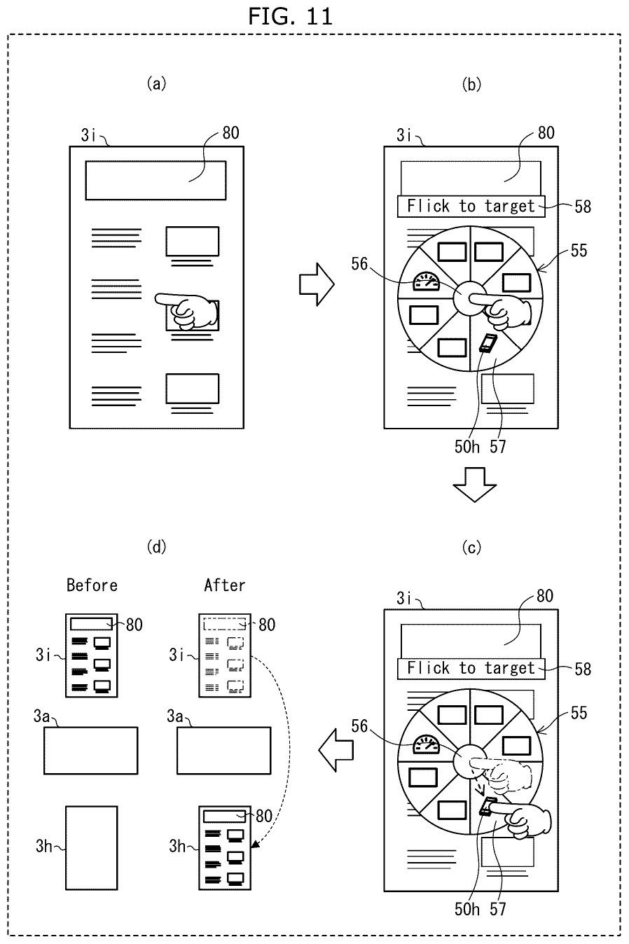

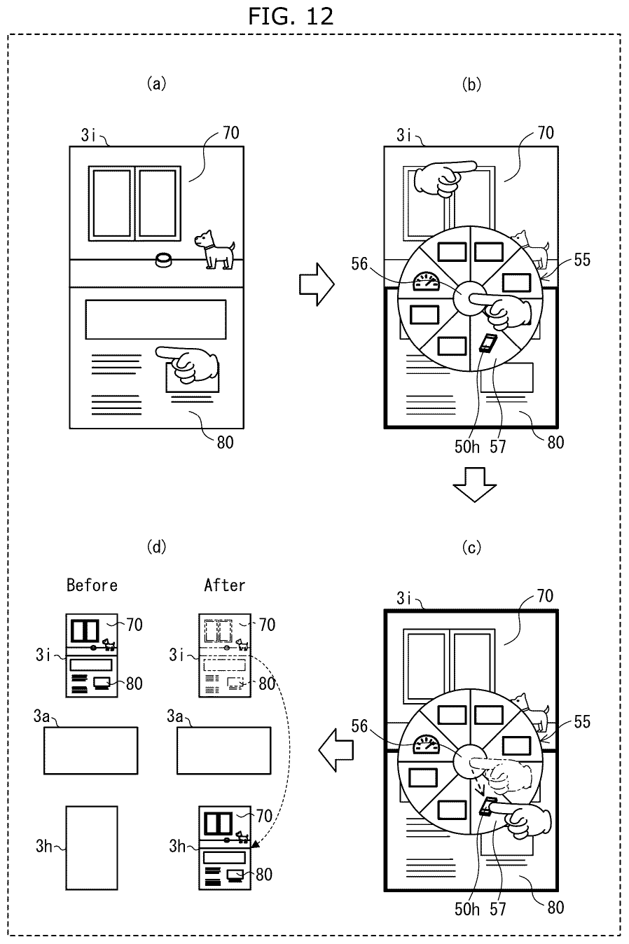

FIGS. 11 and 12 are figures for explaining fifth and sixth operation examples of display control device 10 in FIG. 1. Next, the fifth and sixth operation examples of display control device 10 are described with reference to FIGS. 11 and 12.

First, the fifth operation example is described with reference to FIG. 11. (a) to (c) in FIG. 11 illustrate the first display device, and (d) in FIG. 11 illustrates the first display device, the second display device, and so forth. The fifth operation example differs from the first operation example mainly in the following points.

As illustrated in (a) in FIG. 11, image 80 is displayed on display device 3i. When the third operation is performed on display device 3i, as illustrated in (b) in FIG. 11, first-operation assist 30 assists the first operation by causing display device 3i to display interface 55. Interface 55 includes central area 56 and one or more areas 57 located in a surrounding area of central area 56. One or more areas 57 are arranged in a circle around central area 56. It should be noted that one or more areas 57 may be arranged in a rectangle, with central area 56 at the center. In each of one or more areas 57, a corresponding one of one or more objects representing one or more display devices other than display device 3i among display devices 3a to 3i is located. For instance, first-operation assist 30 causes display device 3i to display interface 55 in which central area 56 is located at a given location or a location touched by the finger that has performed the third operation.

Operation method notifier 29 notifies the method of the first operation by causing display device 3i to display message 58 indicating the method of the first operation.

As illustrated in (c) in FIG. 11, display device 3h is selected as the second display device by flicking from central area 56 included in interface 55 toward area 57 where object 50h representing display device 3h is located. In this way, as illustrated in (d) in FIG. 11, image 80 displayed on display device 3i is output to and displayed on display device 3h.

It should be noted that when the finger leaves central area 56, processing may be stopped and return to the state illustrated in (a) in FIG. 11.

Next, the sixth operation example is described with reference to FIG. 12. (a) to (c) in FIG. 12 illustrate the first display device, and (d) in FIG. 12 illustrates the first display device, the second display device, and so forth. The sixth operation example differs from the fifth operation example mainly in the following points.

As illustrated in (a) in FIG. 12, image 70 and image 80 are displayed on display device 3i. When the third operation is performed on display device 3i, as illustrated in (b) in FIG. 12, first-operation assist 30 assists the first operation by causing display device 3i to display interface 55.

Moreover, second-operation acceptor 31 causes display device 3i to display image 70 and image 80 behind interface 55, and accepts the second operation. For instance, the second operation is performed with a finger different from a flicking finger. The periphery of an image selected by the second operation is shown in bold, which indicates that the image has been selected as an image to be output to the second display device.

As illustrated in (c) in FIG. 12, after image 70 and image 80 to be output are selected from image 70 and image 80 by tapping or swiping, display device 3h is selected as the second display device by flicking from central area 56 toward area 57. In this way, as illustrated in (d) in FIG. 12, image 70 and image 80 displayed on display device 3i are output to and displayed on display device 3h. It should be noted that interface 55 may be displayed after the end of the second operation.

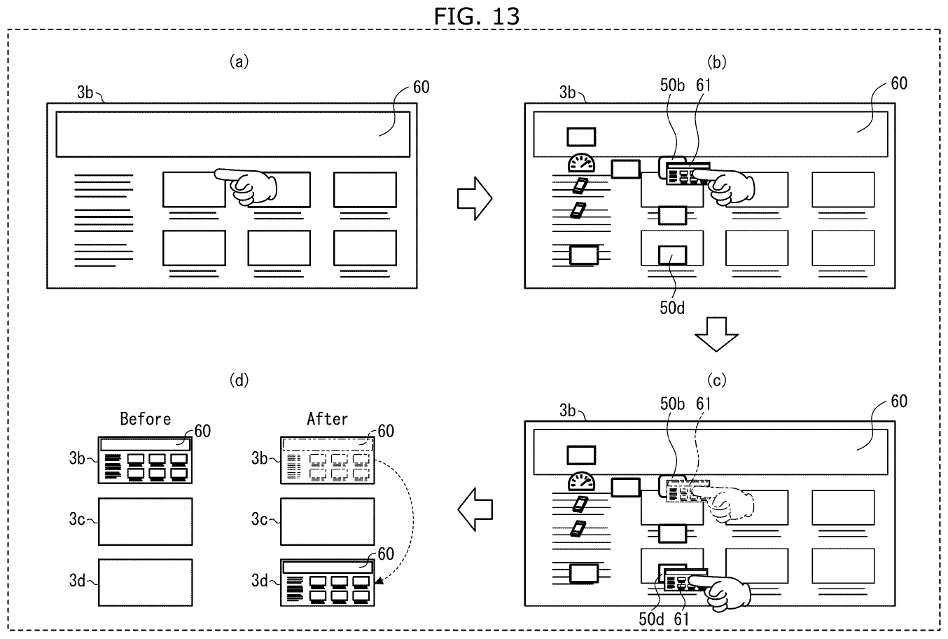

FIGS. 13 to 16 are figures for explaining seventh to tenth operation examples of display control device 10 in FIG. 1. Next, the seventh to tenth operation examples of display control device 10 are described with reference to FIGS. 13 to 16.

First, the seventh operation example is described with reference to FIG. 13. (a) to (c) in FIG. 13 illustrate the first display device, and (d) in FIG. 13 illustrates the first display device, the second display device, and so forth. The seventh operation example differs from the first operation example mainly in the following points.

As illustrated in (a) in FIG. 13, image 60 is displayed on display device 3b. When the third operation is performed on display device 3b, as illustrated in (b) in FIG. 13, first-operation assist 30 assists the first operation by causing display device 3b to display (i) object 50b representing display device 3b among display devices 3a to 3i, (ii) one or more objects representing one or more display devices other than display device 3b, and (iii) object 61 representing image 60. Although object 61 is, for example, a thumbnail of image 60, object 61 may be, for example, another icon.

As illustrated in (c) in FIG. 13, since object 61 is located to overlap object 50b, display device 3d is selected as the second display device by dragging and dropping object 61 onto object 50d representing display device 3d. In this way, as illustrated in (d) in FIG. 13, image 60 displayed on display device 3b is output to and displayed on display device 3d.

It should be noted that when object 61 is dropped onto a position overlapping object 50b, processing may be stopped and return to the state illustrated in (a) in FIG. 13.

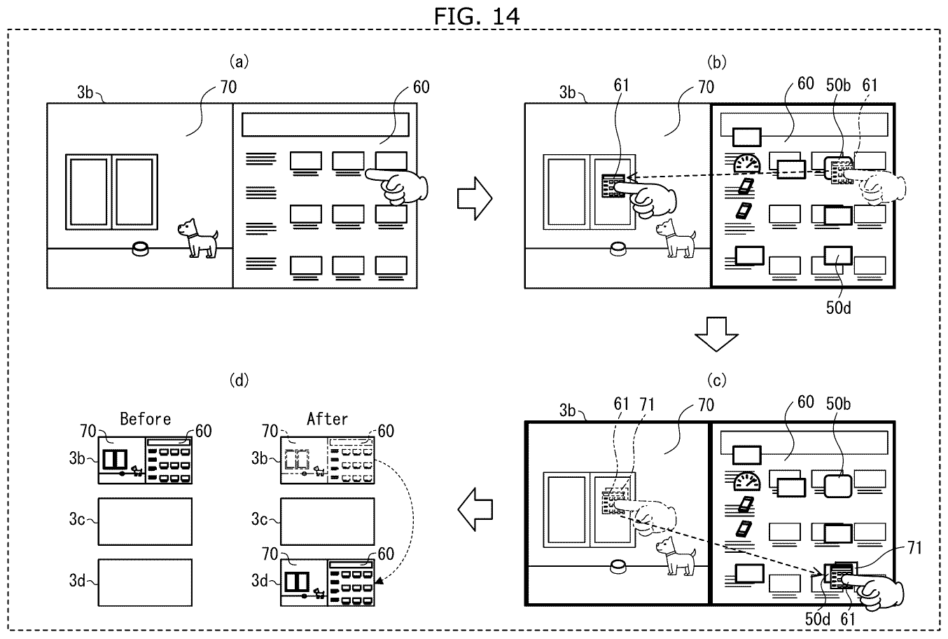

Next, the eighth operation example is described with reference to FIG. 14. (a) to (c) in FIG. 14 illustrate the first display device, and (d) in FIG. 14 illustrates the first display device, the second display device, and so forth. The eighth operation example differs from the seventh operation example mainly in the following points.

As illustrated in (a) in FIG. 14, image 60 and image 70 are displayed on display device 3b. When the third operation is performed on display device 3b, as illustrated in (b) in FIG. 14, first-operation assist 30 assists the first operation by causing display device 3b to display (i) object 50b representing display device 3b among display devices 3a to 3i, (ii) one or more objects representing one or more display devices other than display device 3b, and (iii) object 61 representing image 60. It should be noted that when the third operation is performed in a region displaying image 70, object 71 representing image 70 may be displayed instead of object 61 representing image 60.

Moreover, second-operation acceptor 31 accepts the second operation as a result of causing display device 3b to display image 60 and image 70. Here, image 60 and image 70 are displayed lighter than object 50b and so forth.

When object 61 is dragged onto image 70, as illustrated in (c) in FIG. 14, object 71 representing image 70 is displayed, and image 70 is selected as an image to be output to the second display device. Display device 3d is selected as the second display device by dragging and dropping objects 61 and 71 onto object 50d representing display device 3d. In this way, as illustrated in (d) in FIG. 14, image 60 and image 70 displayed on display device 3b are output to and displayed on display device 3d.

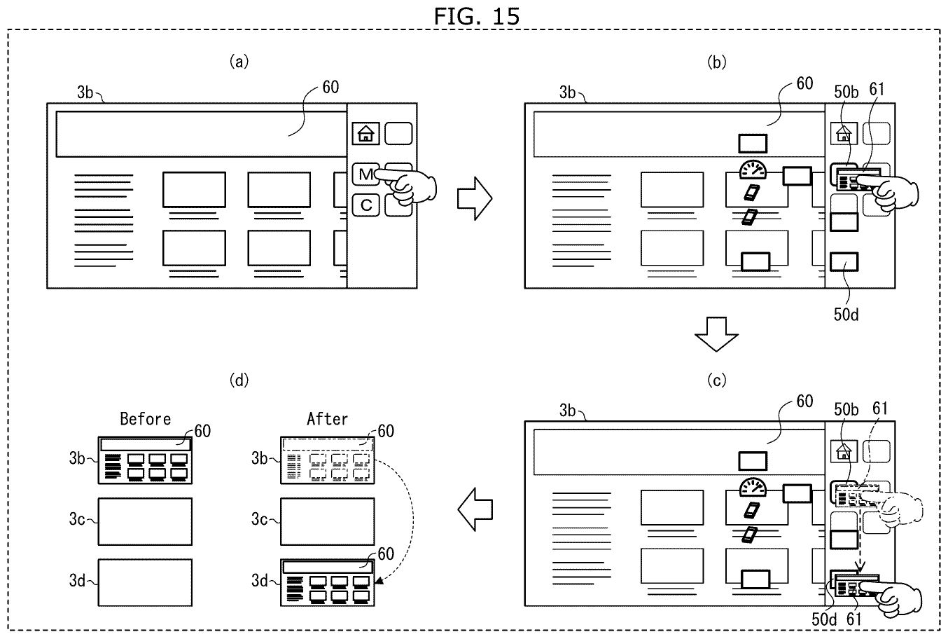

Next, the ninth operation example is described with reference to FIG. 15. (a) to (c) in FIG. 15 illustrate the first display device, and (d) in FIG. 15 illustrates the first display device, the second display device, and so forth. The ninth operation example differs from the seventh operation example mainly in the following points.

As illustrated in (a) in FIG. 15, a button for accepting the third operation is displayed on display device 3b. The third operation is performed by touching or long-pressing the button.

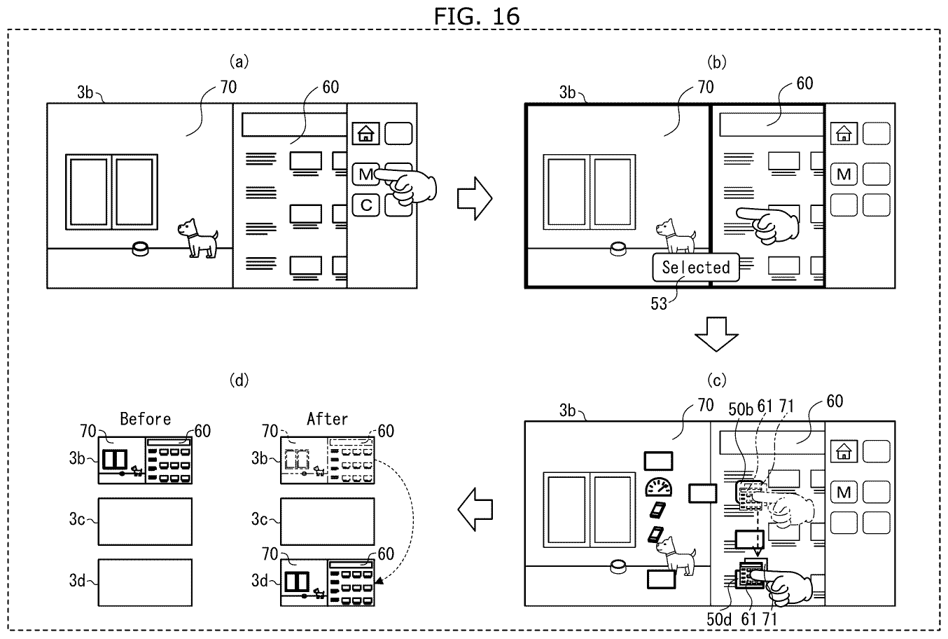

Next, the tenth operation example is described with reference to FIG. 16. (a) to (c) in FIG. 16 illustrate the first display device, and (d) in FIG. 16 illustrates the first display device, the second display device, and so forth. The tenth operation example differs from the eighth operation example mainly in the following points.

As illustrated in (a) in FIG. 16, a button for accepting the third operation is displayed on display device 3b. The third operation is performed by touching or long-pressing the button.

As illustrated in (b) in FIG. 16, when the third operation is performed, second-operation acceptor 31 accepts the second operation as a result of causing image 60 and image 70 to be displayed. Here, the second operation is accepted before object 50b and so forth are displayed. After one or more images to be output to the second display device are selected from image 60 and image 70 by tapping or swiping, when icon 53 is tapped, the second operation ends.

As illustrated in (c) in FIG. 16, when icon 53 is tapped, first-operation assist 30 assists the first operation by causing object 50b and so forth to be displayed.

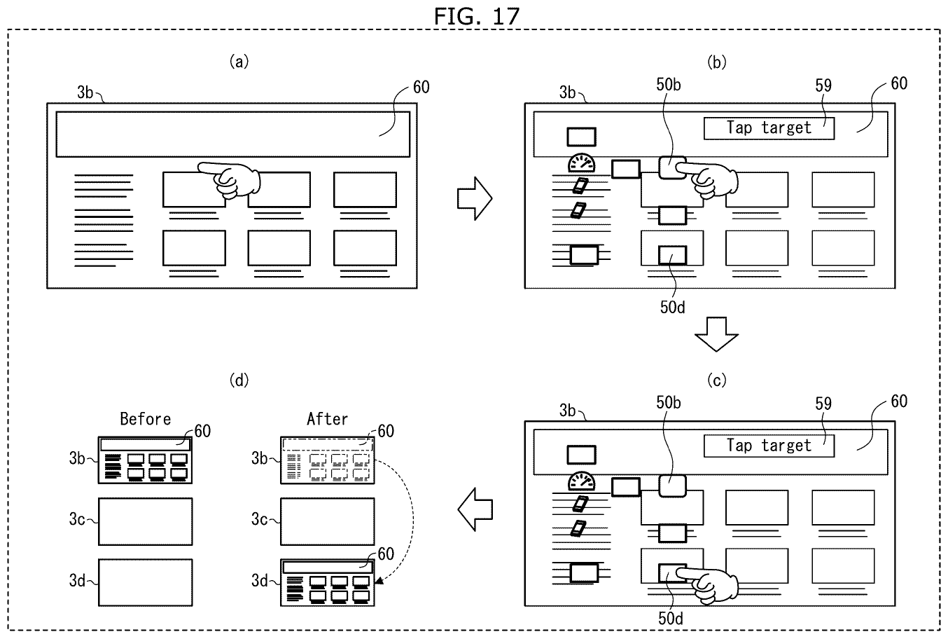

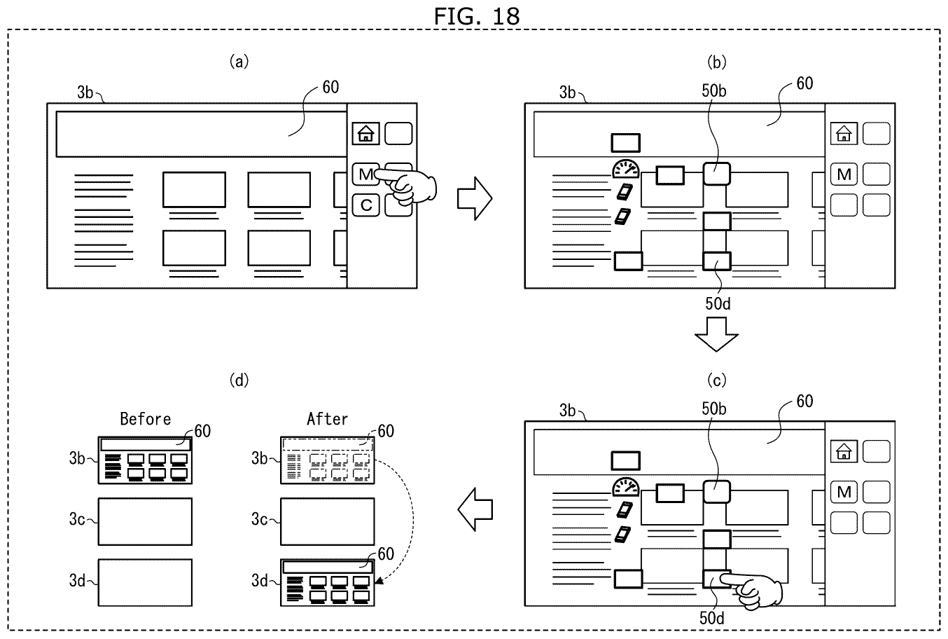

FIGS. 17 and 18 are figures for explaining eleventh and twelfth operation examples of display control device 10 in FIG. 1. Next, the eleventh and twelfth operation examples of display control device 10 are described with reference to FIGS. 17 and 18.

First, the eleventh operation example is described with reference to FIG. 17. (a) to (c) in FIG. 17 illustrate the first display device, and (d) in FIG. 17 illustrates the first display device, the second display device, and so forth. The eleventh operation example differs from the first operation example mainly in the following points.

As illustrated in (a) in FIG. 17, image 60 is displayed on display device 3b. When the third operation is performed on display device 3b, as illustrated in (b) in FIG. 17, first-operation assist 30 assists the first operation by causing display device 3b to display (i) object 50b representing display device 3b among display devices 3a to 3i and (ii) one or more objects representing one or more display devices other than display device 3b.

Operation method notifier 29 notifies the method of the first operation by causing display device 3b to display message 59 indicating the method of the first operation.

As illustrated in (c) in FIG. 17, display device 3d is selected as the second display device by tapping object 50d representing display device 3d. In this way, as illustrated in (d) in FIG. 17, image 60 displayed on display device 3b is output to and displayed on display device 3d.

It should be noted that when image 70 as well as image 60 is displayed, for instance, in the same way as the case illustrated in FIG. 7, second-operation acceptor 31 causes display device 3b to display image 60 and image 70, and accepts the second operation. Image 60 and image 70 to be output are selected from image 60 and image 70 by tapping or swiping.

Next, the twelfth operation example is described with reference to FIG. 18. (a) to (c) in FIG. 18 illustrate the first display device, and (d) in FIG. 18 illustrates the first display device, the second display device, and so forth. The twelfth operation example differs from the eleventh operation example mainly in the following points.

As illustrated in (a) in FIG. 18, a button for accepting the third operation is displayed on display device 3b. The third operation is performed by touching or long-pressing the button.

It should be noted that when image 70 as well as image 60 is displayed, for instance, in the same way as the case illustrated in FIG. 9, second-operation acceptor 31 causes display device 3b to display image 60 and image 70, and accepts the second operation. Image 60 and image 70 to be output are selected from image 60 and image 70 by tapping or swiping. When icon 53 is tapped, the second operation ends.

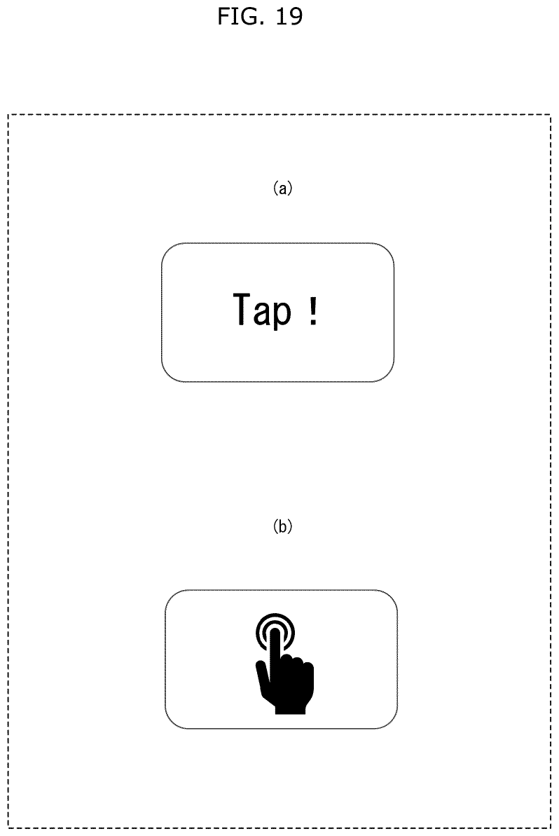

FIG. 19 is a schematic diagram illustrating another example of assistance of the first operation in the eleventh and twelfth operation examples. Next, another example of the assistance of the first operation in the eleventh and twelfth operation examples is described with reference to FIG. 19.

As illustrated in (a) in FIG. 19, a tap prompting text may be displayed on each of object 50b representing display device 3b and one or more objects representing one or more display devices other than display device 3b. Moreover, as illustrated in (b) in FIG. 19, a tap prompting icon may be displayed on each of object 50b representing display device 3b and the one or more objects representing the one or more display devices other than display device 3b.

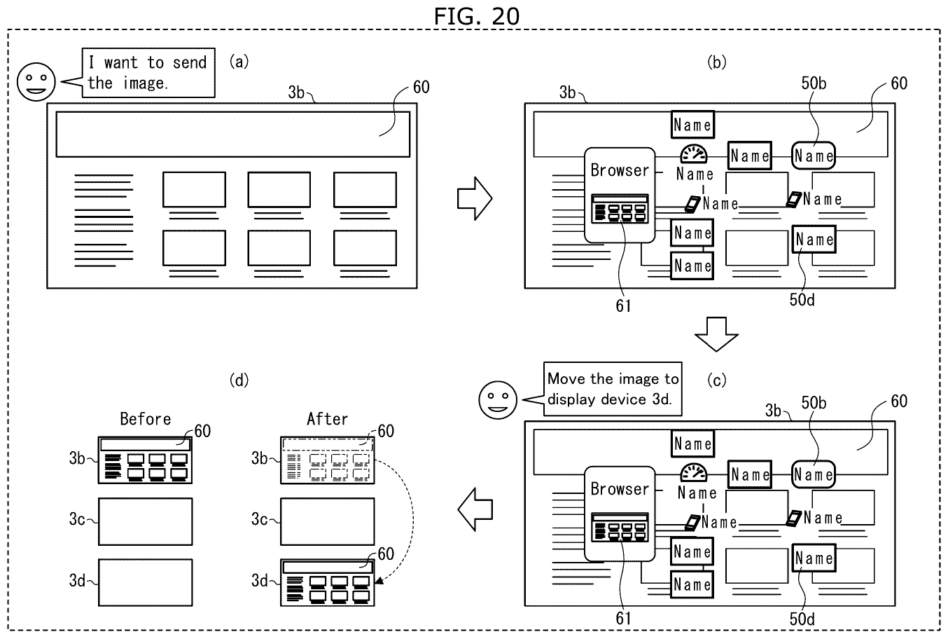

FIG. 20 is a figure for explaining a thirteenth operation example of display control device 10 in FIG. 1. (a) to (c) in FIG. 20 illustrate the first display device, and (d) in FIG. 20 illustrates the first display device, the second display device, and so forth. Next, the thirteenth operation example of display control device 10 is described with reference to FIG. 20.

As illustrated in (a) in FIG. 20, image 60 is displayed on display device 3b. For instance, the third operation is performed by pronouncing specified words into a microphone or the like provided for display device 3b. Specifically, the third operation is performed by pronouncing, for example, “I want to send an image”. It should be noted that at this time, whether to move, copy, or mirror image 60 may be input into the microphone by voice. Moreover, a loudspeaker or the like provided for display device 3b may give a voice instruction to select whether to move, copy, or mirror image 60.

When the third operation is performed on display device 3b, as illustrated in (b) in FIG. 20, first-operation assist 30 assists the first operation by causing display device 3b to display (i) object 50b representing display device 3b among display devices 3a to 3i, (ii) one or more objects representing one or more display devices other than display device 3b, and (iii) device names that are the names of the display devices represented by the objects. It should be noted that the displayed device name of each of display devices 3a to 3i may be overlaid on the object representing the display device, located near the object representing the display device, and connected to the object representing the display device by a line or the like. For instance, the names of display devices 3a to 3i are preregistered by, for example, input by persons 100a to 100d. Object 61 representing image 60 to be output to the second display device is also displayed on display device 3b.

As illustrated in (c) in FIG. 20, display device 3d is selected as the second display device by, for example, pronouncing the name of display device 3d. In this way, as illustrated in (d) in FIG. 20, image 60 displayed on display device 3b is output to and displayed on display device 3d.

It should be noted that display device 3d may be selected as the second display device by pronouncing the position at which display device 3d is located. Specifically, display device 3d may be selected as the second display device by pronouncing, for example, “the display device on the left side of the second row”. In this case, positions at which display devices 3a to 3i are located are displayed on display device 3b in association with the objects representing display devices 3a to 3i.

Moreover, when image 70 as well as image 60 is also displayed, second-operation acceptor 31 may accept the second operation as a result of causing display device 3b to display object 61 and object 71 respectively representing image 60 and image 70 and image names that are the names of target images represented by object 61 and object 71. The displayed image names of image 60 and image 70 may be overlaid on the objects representing the images, located near the objects representing the images, and connected to the objects representing the images by lines or the like. Image 60 and image 70 are selected as images to output to the second display device, by pronouncing the image names of image 60 and image 70 out of image names. For instance, the names of image 60 and image 70 are, for example, the names of applications displaying the images.

Display control device 10 according to the embodiment includes: first-operation assist 30 that assists a first operation of selecting a second display device from among display devices 3a to 3i, each configured to display an image, the second display device being selected to receive an output of and display a target image that is the image displayed on a first display device among display devices 3a to 3i, the second display device being different from the first display device; and second display controller 40 that outputs the target image to the second display device selected by the first operation to cause the second display device to display the target image.

In this way, it is possible to assist the first operation of selecting the second display device from among display devices 3a to 3i. Thus, it is possible to more reliably select the second display device and more reliably output and display the image displayed on the first display device on the second display device.

Moreover, in display control device 10 according to the embodiment, first-operation assist 30 assists the first operation by causing the first display device to display (i) an object representing the first display device, (ii) one or more objects representing one or more display devices other than the first display device among display devices 3a to 3i, and (iii) one or more guide lines extending from the object representing the first display device toward the one or more objects, and the first operation is an operation of selecting the second display device by swiping along a guide line, among the one or more guide lines, that extends from the object representing the first display device toward an object representing the second display device among the one or more objects.

In this way, it is possible to easily determine which direction to swipe from the object representing the first display device to select the second display device. Thus, it is possible to more reliably select the second display device and more reliably output and display the image displayed on the first display device on the second display device.

Moreover, in display control device 10 according to the embodiment, target images each of which is the target image are displayed on the first display device. Display control device 10 includes second-operation acceptor 31 that accepts a second operation of selecting, from the target images, one or more target images to be output to and displayed on the second display device, and the second operation is an operation of selecting the one or more target images by tapping or swiping the one or more target images.

In this way, it is possible to easily select, from the target images displayed on the first display device, the one or more target images to be output to and displayed on the second display device.

Moreover, in display control device 10 according to the embodiment, first-operation assist 30 assists the first operation by causing the first display device to display interface 55 including (i) central area 56 and (ii) one or more areas 57 that are located in a surrounding area of central area 56 and in each of which a corresponding one of one or more objects representing one or more display devices other than the first display device among display devices 3a to 3i is located, and the first operation is an operation of selecting the second display device by flicking from central area 56 toward area 57, among one or more areas 57, where an object representing the second display device among the one or more objects is located.

In this way, it is possible to easily determine which direction to flick from central area 56 to select the second display device. Thus, it is possible to more reliably select the second display device and more reliably output and display the image displayed on the first display device on the second display device.

Moreover, in display control device 10 according to the embodiment, target images each of which is the target image are displayed on the first display device. Display control device 10 includes second-operation acceptor 31 that accepts a second operation of selecting, from the target images, one or more target images to be output to and displayed on the second display device, and the second operation is an operation of selecting the one or more target images by tapping or swiping the one or more target images.

In this way, it is possible to easily select, from the target images displayed on the first display device, the one or more target images to be output to and displayed on the second display device.

Moreover, in display control device 10 according to the embodiment, first-operation assist 30 assists the first operation by causing the first display device to display (i) one or more objects representing one or more display devices other than the first display device among display devices 3a to 3i and (ii) an object representing the target image, and the first operation is an operation of selecting the second display device by dragging and dropping the object representing the target image onto an object representing the second display device among the one or more objects.

In this way, by dragging and dropping the object representing the target image onto the object representing the second display device, it is possible to more reliably select the second display device and more reliably output and display the image displayed on the first display device on the second display device.

Moreover, display control device 10 according to the embodiment, target images each of which is the target image are displayed on the first display device. Display control device 10 includes second-operation acceptor 31 that accepts a second operation of selecting, from the target images, one or more target images to be output to and displayed on the second display device, and the second operation is an operation of selecting the one or more target images by dragging the object representing the target image onto the one or more target images.

In this way, it is possible to easily select, from the target images displayed on the first display device, the one or more target images to be output to and displayed on the second display device.

Moreover, display control device 10 according to the embodiment, first-operation assist 30 assists the first operation by causing the first display device to display one or more objects representing one or more display devices other than the first display device among display devices 3a to 3i, and the first operation is an operation of selecting the second display device by tapping an object representing the second display device out of the one or more objects.

In this way, by tapping the object representing the second display device, it is possible to more reliably select the second display device and more reliably output and display the image displayed on the first display device on the second display device.

Moreover, in display control device 10 according to the embodiment, target images each of which is the target image are displayed on the first display device. Display control device 10 includes second-operation acceptor 31 that accepts a second operation of selecting, from the target images, one or more target images to be output to and displayed on the second display device, and the second operation is an operation of selecting the one or more target images by tapping or swiping the one or more target images.

In this way, it is possible to easily select, from the target images displayed on the first display device, the one or more target images to be output to and displayed on the second display device.

Moreover, in display control device 10 according to the embodiment, first-operation assist 30 assists the first operation by causing the first display device to display (i) one or more objects representing one or more display devices other than the first display device among display devices 3a to 3i and (ii) one or more device names that are one or more names of the one or more display devices represented by the one or more objects, and the first operation is an operation of selecting the second display device by pronouncing the device name of the second display device out of the one or more device names.

In this way, by pronouncing the device name of the second display device, it is possible to more reliably select the second display device and more reliably output and display the image displayed on the first display device on the second display device.

Moreover, in display control device 10 according to the embodiment, target images each of which is the target image are displayed on the first display device. Display control device 10 includes second-operation acceptor 31 that accepts a second operation of selecting, from the target images, one or more target images to be output to and displayed on the second display device, as a result of causing the first display device to display (i) objects representing the target images and (ii) image names that are names of the target images represented by the objects, and the second operation is an operation of selecting the one or more target images by pronouncing the one or more image names of the one or more target images out of the image names.

In this way, it is possible to easily select, from the target images displayed on the first display device, the one or more target images to be output to and displayed on the second display device.

Moreover, display control device 10 according to the embodiment includes: operation method notifier 29 that notifies a method of the first operation.

In this way, it is possible to more reliably perform the first operation. Thus, it is possible to more reliably select the second display device and more reliably output and display the image displayed on the first display device on the second display device.

Moreover, display control device 10 according to the embodiment includes third-operation detector 21 that detects a third operation that triggers start of acceptance of the first operation.

In this way, it is possible to recognize that the acceptance of the first operation is to be accepted. Since it is possible to more reliably assist the first operation, it is possible to more reliably select the second display device and more reliably output and display the image displayed on the first display device on the second display device.

Moreover, in display control device 10 according to the embodiment, display devices 3a to 3i are located in vehicle 1 or carried by persons 100a to 100d in vehicle 1, and display control device 10 includes operation method decision maker 28 that determines a method of the first operation according to a driving status of vehicle 1.

In this way, it is possible to appropriately determine the method of the first operation according to the driving status of vehicle 1. Thus, it is possible to more reliably select the second display device and more reliably output and display the image displayed on the first display device on the second display device.

Moreover, in display control device 10 according to the embodiment, each of display devices 3a to 3i is located in vehicle 1 or carried by persons 100a to 100d in vehicle 1, and display control device 10 includes setting acceptor 22 that accepts a setting to prohibit the first operation using at least one of display devices 3a to 3i.

In this way, it is possible to suppress the first operation from becoming a disturbance to the driving of vehicle 1.

Moreover, a display control method according to the embodiment includes: assisting a first operation of selecting a second display device from among display devices 3a to 3i, each configured to display an image, the second display device being selected to receive an output of and display a target image that is the image displayed on a first display device among display devices 3a to 3i, the second display device being different from the first display device (step S8); and outputting the target image to the second display device selected by the first operation to cause the second display device to display the target image (step S9).

The display control method has an advantage similar to that of display control device 10 described above.

Moreover, a program according to the embodiment is a program for causing a computer to execute the above display control method.

The program has an advantage similar to that of display control device 10 described above.

While an embodiment has been described herein above, it is to be appreciated that various changes in form and detail may be made without departing from the spirit and scope of the present disclosure as presently or hereafter claimed.

### Other Embodiments

Although the display control device and so forth according to one or more aspects are described above on the basis of the embodiment, the present disclosure is not limited to the embodiment. The scope of the present disclosure encompasses embodiments obtained by adding various changes envisioned by those skilled in the art to the embodiment, as long as the resultant embodiments do not depart from the scope of the present disclosure.

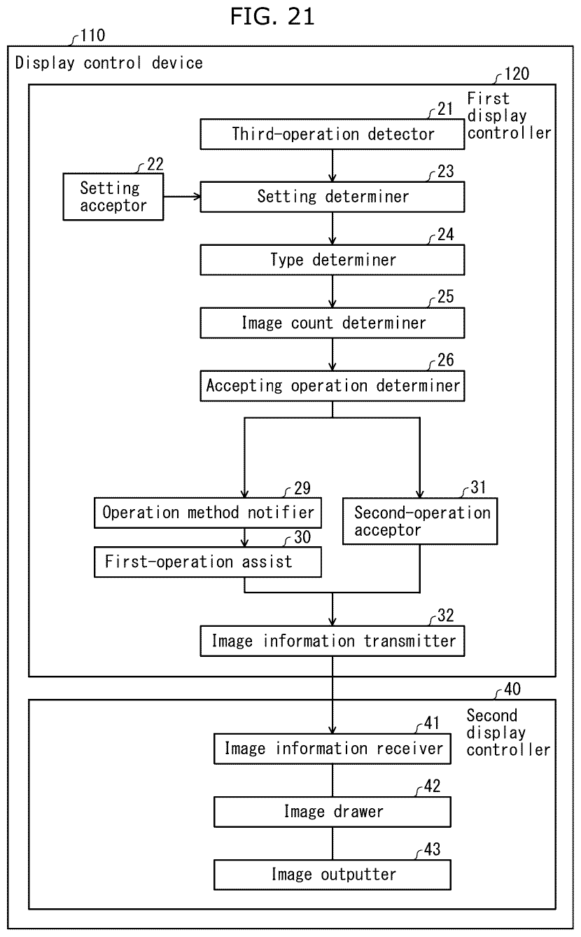

In the above embodiment, a case where display control device 10 includes driving status obtainer 27 and operation method decision maker 28 is described as a non-limiting example. FIG. 21 is a block diagram illustrating a functional configuration of display control device 110 according to another embodiment. As illustrated in FIG. 21, display control device 110 includes first display controller 120 instead of first display controller 20. First display controller 120 differs from first display controller 20 mainly in terms of not including driving status obtainer 27 or operation method decision maker 28. Thus, the display control device need not include a driving status obtainer or an operation method decision maker.

Moreover, in the above embodiment, a case where each of display devices 3a to 3i is located in vehicle 1 or carried by persons 100a to 100d in vehicle 1 is described as a non-limiting example. For instance, the display devices may be located in, for example, a room in a building or may be carried by one or more persons in the room.

It should be noted that in the embodiment, each constituent element may be achieved as dedicated hardware or may be achieved by executing a software program suitable for the constituent element. Each constituent element may be achieved by a program executer, such as a CPU or a processor, reading out and executing a software program stored in a recording medium, such as a hard disk or semiconductor memory. Here, software for achieving the device and so forth described in the above embodiment is a program for causing a computer to perform the steps included in the flowchart illustrated in FIG. 5.

It should be noted that the present disclosure also encompasses the following cases.
(1) Each device described above is specifically a computer system including, for example, a microprocessor, ROM, RAM, a hard disk unit, a display unit, a keyboard, and a mouse. A computer program is stored in the RAM or hard disk unit. The functions of each device are achieved by the microprocessor operating in accordance with the computer program. Here, the computer program is constructed by combining two or more instruction codes to command a computer to achieve a predetermined function.
(2) Some or all of constituent elements included in each device described above may be configured as a single system large scale integration (LSI). A system LSI is a super multifunctional LSI manufactured by integrating parts into one chip, and specifically a computer system including a microprocessor, ROM, and RAM. A computer program is stored in the RAM. The functions of the system LSI are achieved by the microprocessor operating in accordance with the computer program.
(3) Some or all of the constituent elements included in each device described above may be configured as an IC card or a single module detachable from and attachable to the device. The IC card or the module is a computer system including a microprocessor, ROM, and RAM. The IC card or the module may include the above super multifunctional LSI. The functions of IC card or the module are achieved by the microprocessor operating in accordance with the computer program. The IC card or the module may be tamper-resistant.
(4) The present disclosure may be the methods described above. Moreover, the present disclosure may be a computer program to achieve the methods using a computer, and may be a digital signal representing the computer program.

Moreover, the present disclosure may be the computer program or the digital signal stored in a computer-readable recording medium, such as a flexible disk, a hard disk, a CD-ROM, an MO, a DVD, a DVD-ROM, a DVD-RAM, a Blu-ray (registered trademark) Disc (BD), or semiconductor memory. Moreover, the present disclosure may be the digital signal recorded on these recording media.

Moreover, the present disclosure may relate to transmission of the computer program or the digital signal via, for example, a network or data broadcasting typified by a telecommunication line, a wireless or wired communication line, or the Internet.

Moreover, the present disclosure may be a computer system including a microprocessor and memory. The computer program may be stored in the memory, and the microprocessor may operate in accordance with the computer program.

Moreover, another independent computer system may be caused to perform the method by transferring the program or the digital signal stored in the recording medium to the independent computer system or transferring the program or the digital signal to the independent computer system via, for example, the network.
(5) The above embodiment and another embodiment may be combined.

### Supplementary Notes

The following techniques are disclosed by the statements in the above embodiment and so forth.

### (Technique 1)

A display control device including:
a first-operation assist that assists a first operation of selecting a second display device from among a plurality of display devices, each configured to display an image, the second display device being selected to receive an output of and display a target image that is the image displayed on a first display device among the plurality of display devices, the second display device being different from the first display device; and
a controller that outputs the target image to the second display device selected by the first operation to cause the second display device to display the target image.

### (Technique 2)

The display control device according to technique 1, in which
the first-operation assist assists the first operation by causing the first display device to display (i) an object representing the first display device, (ii) one or more objects representing one or more display devices other than the first display device among the plurality of display devices, and (iii) one or more guide lines extending from the object representing
the first display device toward the one or more objects, and the first operation is an operation of selecting the second display device by swiping along a guide line, among the one or more guide lines, that extends from the object representing the first display device toward an object representing the second display device among the one or more objects.

### (Technique 3)

The display control device according to technique 2, in which
target images each of which is the target image are displayed on the first display device,
the display control device further includes:
a second-operation acceptor that accepts a second operation of selecting, from the target images, one or more target images to be output to and displayed on the second display device, and
the second operation is an operation of selecting the one or more target images by tapping or swiping the one or more target images.

### (Technique 4)

The display control device according to technique 1, in which
the first-operation assist assists the first operation by causing the first display device to display an interface including (i) a central area and (ii) one or more areas that are located in a surrounding area of the central area and in each of which a corresponding one of one or more objects representing one or more display devices other than the first display device among the plurality of display devices is located, and
the first operation is an operation of selecting the second display device by flicking from the central area toward an area, among the one or more areas, where an object representing the second display device among the one or more objects is located.

### (Technique 5)

The display control device according to technique 4, in which
target images each of which is the target image are displayed on the first display device,
the display control device further includes:
a second-operation acceptor that accepts a second operation of selecting, from the target images, one or more target images to be output to and displayed on the second display device, and
the second operation is an operation of selecting the one or more target images by tapping or swiping the one or more target images.

### (Technique 6)

The display control device according to technique 1, in which
the first-operation assist assists the first operation by causing the first display device to display (i) one or more objects representing one or more display devices other than the first display device among the plurality of display devices and (ii) an object representing the target image, and
the first operation is an operation of selecting the second display device by dragging and dropping the object representing the target image onto an object representing the second display device among the one or more objects.

### (Technique 7)

The display control device according to technique 6, in which
target images each of which is the target image are displayed on the first display device,
the display control device further includes:
a second-operation acceptor that accepts a second operation of selecting, from the target images, one or more target images to be output to and displayed on the second display device, and
the second operation is an operation of selecting the one or more target images by dragging the object representing the target image onto the one or more target images.

### (Technique 8)

The display control device according to technique 1, in which
the first-operation assist assists the first operation by causing the first display device to display one or more objects representing one or more display devices other than the first display device among the plurality of display devices, and
the first operation is an operation of selecting the second display device by tapping an object representing the second display device out of the one or more objects.

### (Technique 9)

The display control device according to technique 8, in which
target images each of which is the target image are displayed on the first display device,
the display control device further includes:
a second-operation acceptor that accepts a second operation of selecting, from the target images, one or more target images to be output to and displayed on the second display device, and
the second operation is an operation of selecting the one or more target images by tapping or swiping the one or more target images.

### (Technique 10)

The display control device according to technique 1, in which
the first-operation assist assists the first operation by causing the first display device to display (i) one or more objects representing one or more display devices other than the first display device among the plurality of display devices and (ii) one or more device names that are one or more names of the one or more display devices represented by the one or more objects, and
the first operation is an operation of selecting the second display device by pronouncing a device name of the second display device out of the one or more device names.

### (Technique 11)

The display control device according to technique 10, in which
target images each of which is the target image are displayed on the first display device,
the display control device further includes:
a second-operation acceptor that accepts a second operation of selecting, from the target images, one or more target images to be output to and displayed on the second display device, as a result of causing the first display device to display (i) objects representing the target images and (ii) image names that are names of the target images represented by the objects, and
the second operation is an operation of selecting the one or more target images by pronouncing one or more image names of the one or more target images out of the image names.

### (Technique 12)

The display control device according to any one of techniques 1 to 11, further including:
a notifier that notifies a method of the first operation.

### (Technique 13)

The display control device according to any one of techniques 1 to 12, further including:
a third-operation detector that detects a third operation that triggers start of acceptance of the first operation.

### (Technique 14)

The display control device according to any one of techniques 1 to 13, in which
each of the plurality of display devices is located in a vehicle or carried by one or more persons in the vehicle, and
the display control device further includes:
a decision maker that determines a method of the first operation according to a driving status of the vehicle.

### (Technique 15)

The display control device according to any one of techniques 1 to 13, in which
each of the plurality of display devices is located in a vehicle or carried by one or more persons in the vehicle, and
the display control device further includes:
a setting acceptor that accepts a setting to prohibit the first operation using at least one of the plurality of display devices.

### (Technique 16)

A display control method including:
assisting a first operation of selecting a second display device from among a plurality of display devices, each configured to display an image, the second display device being selected to receive an output of and display a target image that is the image displayed on a first display device among the plurality of display devices, the second display device being different from the first display device; and
outputting the target image to the second display device selected by the first operation to cause the second display device to display the target image.

### (Technique 17)

A program for causing a computer to execute the display control method according to technique 16.

### Further Information About Technical Background to This Application

The disclosures of the following patent applications including specification, drawings, and claims are incorporated herein by reference in their entirety: Japanese Patent Application No. 2023-167767 filed on Sep. 28, 2023 and PCT International Application No. PCT/JP2024/028517 filed on Aug. 8, 2024.

### INDUSTRIAL APPLICABILITY

The present disclosure is applicable to, for example, a device that controls displaying of an image on a display device.

1. A display control device comprising:
a processor; and
memory connected to the processor, wherein
using the memory, the processor:
assists a first operation of selecting a second display device from among a plurality of display devices, each configured to display an image, the second display device being selected to receive an output of and display a target image that is the image displayed on a first display device among the plurality of display devices, the second display device being different from the first display device; and
outputs the target image to the second display device selected by the first operation to cause the second display device to display the target image.

2. The display control device according to claim 1, wherein
in assisting the first operation, the processor assists the first operation by causing the first display device to display (i) an object representing the first display device, (ii) one or more objects representing one or more display devices other than the first display device among the plurality of display devices, and (iii) one or more guide lines extending from the object representing the first display device toward the one or more objects, and
the first operation is an operation of selecting the second display device by swiping along a guide line, among the one or more guide lines, that extends from the object representing the first display device toward an object representing the second display device among the one or more objects.

3. The display control device according to claim 2, wherein
target images each of which is the target image are displayed on the first display device,
the processor accepts a second operation of selecting, from the target images, one or more target images to be output to and displayed on the second display device, and
the second operation is an operation of selecting the one or more target images by tapping or swiping the one or more target images.

4. The display control device according to claim 1, wherein
in assisting the first operation, the processor assists the first operation by causing the first display device to display an interface including (i) a central area and (ii) one or more areas that are located in a surrounding area of the central area and in each of which a corresponding one of one or more objects representing one or more display devices other than the first display device among the plurality of display devices is located, and
the first operation is an operation of selecting the second display device by flicking from the central area toward an area, among the one or more areas, where an object representing the second display device among the one or more objects is located.

5. The display control device according to claim 4, wherein
target images each of which is the target image are displayed on the first display device,
the processor accepts a second operation of selecting, from the target images, one or more target images to be output to and displayed on the second display device, and
the second operation is an operation of selecting the one or more target images by tapping or swiping the one or more target images.

6. The display control device according to claim 1, wherein
in assisting the first operation, the processor assists the first operation by causing the first display device to display (i) one or more objects representing one or more display devices other than the first display device among the plurality of display devices and (ii) an object representing the target image, and
the first operation is an operation of selecting the second display device by dragging and dropping the object representing the target image onto an object representing the second display device among the one or more objects.

7. The display control device according to claim 6, wherein
target images each of which is the target image are displayed on the first display device,
the processor accepts a second operation of selecting, from the target images, one or more target images to be output to and displayed on the second display device, and
the second operation is an operation of selecting the one or more target images by dragging the object representing the target image onto the one or more target images.

8. The display control device according to claim 1, wherein
in assisting the first operation, the processor assists the first operation by causing the first display device to display one or more objects representing one or more display devices other than the first display device among the plurality of display devices, and
the first operation is an operation of selecting the second display device by tapping an object representing the second display device out of the one or more objects.

9. The display control device according to claim 8, wherein
target images each of which is the target image are displayed on the first display device,
the processor accepts a second operation of selecting, from the target images, one or more target images to be output to and displayed on the second display device, and
the second operation is an operation of selecting the one or more target images by tapping or swiping the one or more target images.

10. The display control device according to claim 1, wherein
in assisting the first operation, the processor assists the first operation by causing the first display device to display (i) one or more objects representing one or more display devices other than the first display device among the plurality of display devices and (ii) one or more device names that are one or more names of the one or more display devices represented by the one or more objects, and
the first operation is an operation of selecting the second display device by pronouncing a device name of the second display device out of the one or more device names.

11. The display control device according to claim 10, wherein
target images each of which is the target image are displayed on the first display device,
the processor accepts a second operation of selecting, from the target images, one or more target images to be output to and displayed on the second display device, as a result of causing the first display device to display (i) objects representing the target images and (ii) image names that are names of the target images represented by the objects, and
the second operation is an operation of selecting the one or more target images by pronouncing one or more image names of the one or more target images out of the image names.

12. The display control device according to claim 1, wherein
the processor notifies a method of the first operation.

13. The display control device according to claim 1, wherein
the processor detects a third operation that triggers start of acceptance of the first operation.

14. The display control device according to claim 1, wherein
each of the plurality of display devices is located in a vehicle or carried by one or more persons in the vehicle, and
the processor determines a method of the first operation according to a driving status of the vehicle.

15. The display control device according to claim 1, wherein
each of the plurality of display devices is located in a vehicle or carried by one or more persons in the vehicle, and
the processor accepts a setting to prohibit the first operation using at least one of the plurality of display devices.

16. A display control method performed by a computer, the display control method comprising:
assisting a first operation of selecting a second display device from among a plurality of display devices, each configured to display an image, the second display device being selected to receive an output of and display a target image that is the image displayed on a first display device among the plurality of display devices, the second display device being different from the first display device; and
outputting the target image to the second display device selected by the first operation to cause the second display device to display the target image.
